(19) United States
(12) Patent Application Publication
(10) Pub. No.: US 2024/0337958 A1
(43) Pub. Date: Oct. 10, 2024

(54) ELECTROPHOTOGRAPHIC PHOTORECEPTOR, PROCESS CARTRIDGE, AND IMAGE FORMING APPARATUS

(71) Applicant: FUJIFILM Business Innovation Corp., Tokyo (JP)

(72) Inventors: Yoichi KIGOSHI, Kanagawa (JP); Masahiro Iwasaki, Kanagawa (JP); Yuki Oyamada, Kanagawa (JP); Kenta Ide, Kanagawa (JP)

(73) Assignee: FUJIFILM Business Innovation Corp., Tokyo (JP)

(21) Appl. No.: 18/458,686

(22) Filed: Aug. 30, 2023

(30) Foreign Application Priority Data
Mar. 27, 2023 (JP) 2023-050461

(51) Int. Cl. G03G 5/07; G03G 21/18

(52) U.S. Cl. CPC G03G 5/078; G03G 21/1814

(57) ABSTRACT

An electrophotographic photoreceptor includes a base material and a photosensitive layer on the base material, in which an outermost layer constituting an outermost surface contains a total of 0.0010 ppm or greater of at least one selected from the group consisting of cyclic siloxane compounds represented by General Formulae (1), (2), (3), and (4),

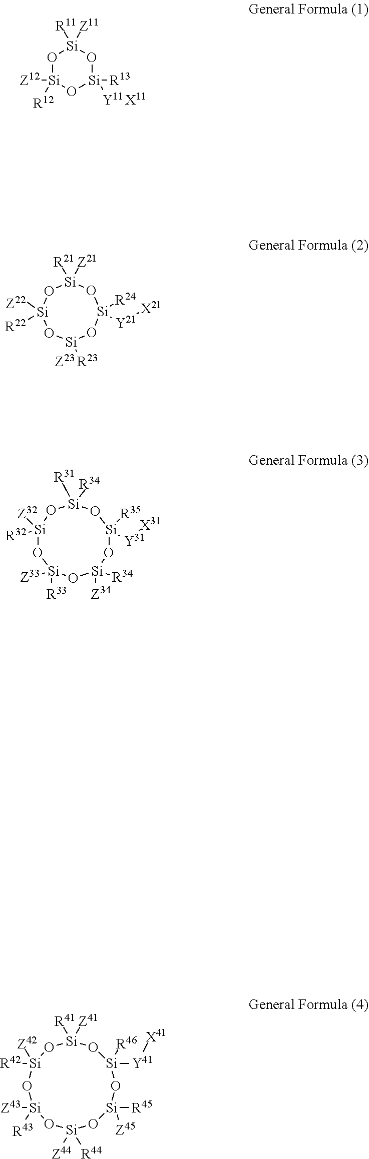

(in General Formulae (1), (2), (3), and (4), R¹, R¹², R¹³, R²¹, R²², R²³, R²⁴, R³¹, R³², R³³, R³⁴, R³⁵, R⁴¹, R⁴², R⁴³, R⁴⁴, R⁴⁵, and R⁴⁶ each independently represent a hydrogen atom or a monovalent alkyl group that may have a substituent, Z¹¹, Z¹², Z²¹, Z²², Z²³, Z³¹, Z³², Z³³, Z³⁴, Z⁴¹, Z⁴², Z⁴³, Z⁴⁴, and Z⁴⁵ each independently represent a group represented by —Y¹²—X¹², a hydrogen atom, or a monovalent alkyl group that may have a substituent, X¹¹, X¹², X²¹, X²², X³¹, X³², X⁴¹, and X⁴² each independently represent a monovalent functional group selected from the group consisting of a succinic anhydride group, a (meth)acrylic group, an alicyclic epoxy group, an amino group, a hydroxyl group, and a glycidyl group, and Y¹¹, Y¹², Y²¹, Y²², Y³¹, Y³², Y⁴¹, and Y⁴² each independently represent a divalent organic linking group).

### CROSS-REFERENCE TO RELATED APPLICATIONS

This application is based on and claims priority under 35 USC 119 from Japanese Patent Application No. 2023-050461 filed Mar. 27, 2023.

### BACKGROUND

### (i) Technical Field

The present invention relates to an electrophotographic photoreceptor, a process cartridge, and an image forming apparatus.

### (ii) Related Art

JP1998-239887A discloses an electrophotographic photoreceptor including a photosensitive layer and a protective layer in order on a conductive substrate, in which the protective layer contains a charge transport agent containing at least two hydroxy functional groups, silicone oil containing at least one hydroxy functional group, and at least one binder resin capable of forming the hydroxy functional group and a hydrogen bond.

JP4322468B discloses an electrophotographic photoreceptor including a conductive support and a photosensitive layer disposed on the support, in which the photosensitive layer includes a silicon compound-containing layer containing a cyclic siloxane compound that has a cyclic structure having a repeating unit represented by General Formula (1) and/or a derivative thereof.

JP3015074B discloses a method of forming an electrophotographic photoreceptor coating film, including applying a coating film for an electrophotographic photoreceptor, which contains silicone oil having a siloxane structure with a molecular weight of 1,000 or less, as a volatile leveling agent and heating and drying the coating material so that the leveling agent is volatilized, to form a coating film.

### SUMMARY

Meanwhile, the cleaning performance of the electrophotographic photoreceptor is degraded in a case where the surface roughness of an outer peripheral surface of the electrophotographic photoreceptor is increased, and thus defects may occur in an image to be formed on a recording medium due to the influence of a toner or the like remaining on the outer peripheral surface.

Aspects of non-limiting embodiments of the present disclosure relate to an electrophotographic photoreceptor that has an outer peripheral surface with reduced roughness as compared with an electrophotographic photoreceptor including an outermost layer that contains only 0.0010 ppm or greater of “KP340” (manufactured by Shin-Etsu Chemical Co., Ltd.) as silicone oil, a process cartridge that includes the electrophotographic photoreceptor, and an image forming apparatus.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

Specific means for achieving the above-described object includes the following aspects.

According to an aspect of the present disclosure, there is provided an electrophotographic photoreceptor including a base material; and a photosensitive layer on the base material, in which an outermost layer constituting an outermost surface contains a total of 0.0010 ppm or greater of at least one selected from the group consisting of cyclic siloxane compounds represented by General Formulae (1), (2), (3), and (4),

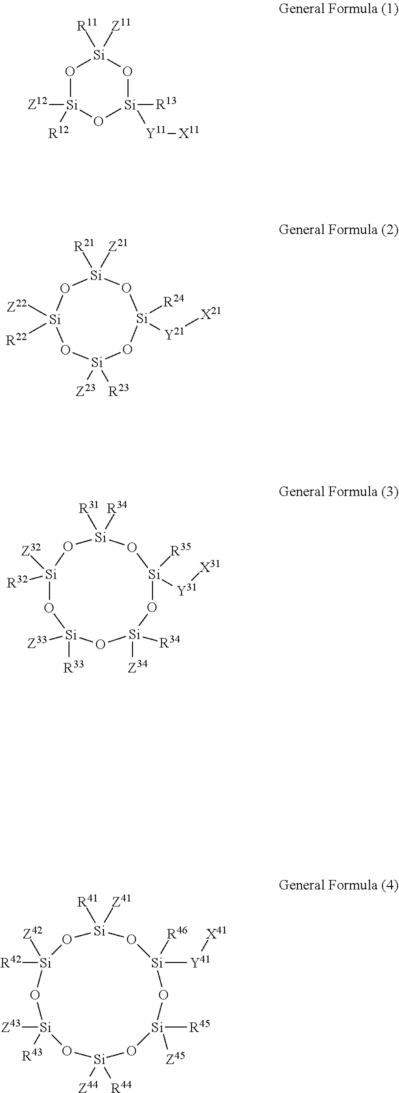

(in General Formulae (1), (2), (3), and (4), R¹¹, R¹², R¹³, R²¹, R²², R²³, R²⁴, R³¹, R³², R³³, R³⁴, R³⁵, R⁴¹, R⁴², R⁴³, R⁴⁴, R⁴⁵, and R⁴⁶ each independently represent a hydrogen atom or a monovalent alkyl group that may have a substituent, Z¹¹, Z¹², Z²¹, Z²², Z²³, Z³¹, Z³², Z³³, Z³⁴, Z⁴¹, Z⁴², Z⁴³, Z⁴⁴, and Z⁴⁵ each independently represent a group represented by —Y¹²—X¹², a hydrogen atom, or a monovalent alkyl group that may have a substituent, X¹¹, X¹², X²¹, X²², X³¹, X³², X⁴¹, and X⁴² each independently represent a monovalent functional group selected from the group consisting of a succinic anhydride group, a (meth)acrylic group, an alicyclic epoxy group, an amino group, a hydroxyl group, and a glycidyl group, and Y¹¹, Y¹², Y²¹, Y²², Y³¹, Y³², Y⁴¹, and Y⁴² each independently represent a divalent organic linking group).

### BRIEF DESCRIPTION OF THE DRAWINGS

Exemplary embodiment(s) of the present invention will be described in detail based on the following figures, wherein:

FIG. 1 is a schematic cross-sectional view showing an example of a layer configuration of an electrophotographic photoreceptor according to the present exemplary embodiment;

FIG. 2 is a schematic configuration view showing an example of an image forming apparatus according to the present exemplary embodiment; and

FIG. 3 is a schematic configuration diagram showing another example of the image forming apparatus according to the present exemplary embodiment.

### DETAILED DESCRIPTION

Hereinafter, exemplary embodiments of the present disclosure will be described. The following descriptions and examples merely illustrate the exemplary embodiments, and do not limit the scope of the exemplary embodiments.

In a numerical range described in a stepwise manner in the present specification, an upper limit or a lower limit described in a certain numerical range may be replaced with an upper limit or a lower limit in another numerical range described in a stepwise manner. Further, in a numerical range described in the present disclosure, an upper limit or a lower limit described in the numerical range may be replaced with a value shown in Examples.

In the present specification, each component may include a plurality of kinds of substances corresponding to each component.

In the present specification, in a case where a plurality of kinds of substances corresponding to each component in a composition are present, the amount of each component in the composition indicates the total amount of the plurality of kinds of substances present in the composition unless otherwise specified.

### Electrophotographic Photoreceptor

An electrophotographic photoreceptor according to an exemplary embodiment of the present disclosure (hereinafter, also simply referred to as “photoreceptor”) includes a base material and a photosensitive layer on the base material. Further, an outermost layer constituting an outermost surface contains a total of 0.0010 ppm or greater of at least one selected from the group consisting of cyclic siloxane compounds represented by General Formulae (1), (2), (3), and (4).

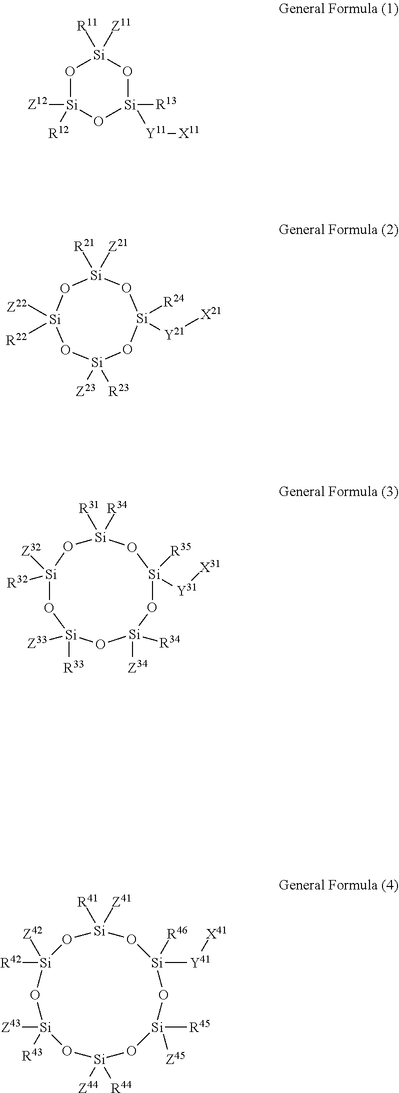

(In General Formulae (1), (2), (3), and (4), R¹¹, R¹², R¹³, R²¹, R²², R²³, R²⁴, R³¹, R³², R³³, R³⁴, R³⁵, R⁴¹, R⁴², R⁴³, R⁴⁴, R⁴⁵, and R⁴⁶ each independently represent a hydrogen atom or a monovalent alkyl group that may have a substituent, Z¹¹, Z¹², Z²¹, Z²², Z²³, Z³¹, Z³², Z³³, Z³⁴, Z⁴¹, Z⁴², Z⁴³, Z⁴⁴, and Z⁴⁵ each independently represent a group represented by —Y¹²—X¹², a hydrogen atom, or a monovalent alkyl group that may have a substituent, X¹¹, X¹², X²¹, X²², X³¹, X³², X⁴¹, and X⁴² each independently represent a monovalent functional group selected from the group consisting of a succinic anhydride group, a (meth)acrylic group, an alicyclic epoxy group, an amino group, a hydroxyl group, and a glycidyl group, and Y¹¹, Y¹², Y²¹, Y²², Y³¹, Y³², Y⁴¹ and Y⁴² each independently represent a divalent organic linking group.)

According to the exemplary embodiment of the present disclosure, in the photoreceptor containing the cyclic siloxane compound, the roughness of the outer peripheral surface is reduced. The reason why the effect is exhibited is assumed as follows.

The cleaning performance of the photoreceptor is degraded in a case where the roughness of the outer peripheral surface of the photoreceptor is increased (that is, the surface roughness is increased), and thus defects may occur in an image to be formed on a recording medium due to the influence of a toner or the like remaining on the outer peripheral surface. Further, in the surface roughness of the outer peripheral surface of the photoreceptor, for example, the surface of the photoreceptor may be roughened due to the influence of curing and shrinkage occurring in the surface of the coating film in a drying step carried out after application of a coating solution for forming an outermost layer in the formation of the outermost layer.

Meanwhile, the photoreceptor according to the exemplary embodiment of the present disclosure contains at least one selected from the group consisting of cyclic siloxane compounds represented by General Formulae (1), (2), (3), and (4) in the above-described amount. In a case where the photoreceptor contains the cyclic siloxane compound represented by the general formula, stress relaxation due to a cyclic siloxane skeleton is exhibited, curing shrinkage of the outermost layer is relaxed, and the roughness of the outer peripheral surface is reduced. As a result, the degradation of the cleaning performance of the photoreceptor is suppressed, and the occurrence of image defects due to the influence of the toner or the like remaining on the outer peripheral surface is suppressed.

### Cyclic Siloxane Compound

Here, the cyclic siloxane compound contained in the outermost layer of the photoreceptor according to the exemplary embodiment of the present disclosure will be described. The cyclic siloxane compound has a structure represented by General Formula (1), (2), (3), or (4).

In General Formulae (1), (2), (3), and (4), R¹¹, R¹², R¹³, R²¹, R²², R²³, R²⁴, R³¹, R³², R³³, R³⁴, R³⁵, R⁴¹, R⁴², R⁴³, R⁴⁴, R⁴⁵, and R⁴⁶ each independently represent a hydrogen atom or a monovalent alkyl group that may have a substituent. From the viewpoint of reducing the roughness of the outer peripheral surface of the photoreceptor, it is preferable that R¹¹, R¹², R¹³, R²¹, R²², R²³, R²⁴, R³¹, R³², R³³, R³⁴, R³⁵, R⁴¹, R⁴², R⁴³, R⁴⁴, R⁴⁵, and R⁴⁶ each independently represent, for example, a hydrogen atom or a monovalent alkyl group having 1 or more and 10 or less carbon atoms that may have a substituent.

The monovalent alkyl group represented by R¹¹, R¹², R¹³, R²¹, R²², R²³, R²⁴, R³¹, R³², R³³, R³⁴, R³⁵, R⁴¹, R⁴², R⁴³, R⁴⁴, R⁴⁵, and R⁴⁶ may have a substituent.

Examples of the unsubstituted alkyl group include a linear alkyl group having 1 or more and 20 or less carbon atoms (for example, preferably 1 or more and 10 or less carbon atoms and more preferably 1 or more and 6 or less carbon atoms), a branched alkyl group having 3 or more and 20 or less carbon atoms (for example, preferably 3 or more and 10 or less carbon atoms), and a cyclic alkyl group having 3 or more and 20 or less carbon atoms (for example, preferably 3 or more and 10 or less carbon atoms).

Examples of the linear alkyl group having 1 or more and 20 or less carbon atoms include a methyl group, an ethyl group, an n-propyl group, an n-butyl group, an n-pentyl group, an n-hexyl group, an n-heptyl group, an n-octyl group, an n-nonyl group, an n-decyl group, an n-undecyl group, an n-dodecyl group, a tridecyl group, an n-tetradecyl group, an n-pentadecyl group, an n-heptadecyl group, an n-octadecyl group, an n-nonadecyl group, and an n-icosyl group.

Examples of the branched alkyl group having 3 or more and 20 or less carbon atoms include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, a tert-decyl group, an isododecyl group, a sec-dodecyl group, a tert-dodecyl group, a tert-tetradecyl group, and a tert-pentadecyl group.

Examples of the cyclic alkyl group having 3 or more and 20 or less carbon atoms include a cyclopropyl group, a cyclobutyl group, a cyclopentyl group, a cyclohexyl group, a cycloheptyl group, a cyclooctyl group, a cyclononyl group, a cyclodecyl group, and polycyclic (for example, bicyclic, tricyclic, or spirocyclic) alkyl groups formed by these monocyclic alkyl groups being linked to each other.

Among these, for example, a linear alkyl group such as a methyl group or an ethyl group is preferable as the unsubstituted alkyl group.

Examples of the substituent in the alkyl group include an alkoxy group, a hydroxy group, a carboxy group, a nitro group, and a halogen atom (such as a fluorine atom, a bromine atom, or an iodine atom).

In General Formulae (1), (2), (3) and (4), Z¹¹, Z¹², Z²¹, Z²², Z²³, Z³¹, Z³², Z³³, Z³⁴, Z⁴¹, Z⁴², Z⁴³, Z⁴⁴, and Z⁴⁵ each independently represent a group represented by —Y¹²—X¹², a hydrogen atom, or a monovalent alkyl group that may have a substituent. Examples of the monovalent alkyl group that may have a substituent as Z¹¹, Z¹², Z²¹, Z²², Z²³, Z³¹, Z³², Z³³, Z³⁴, Z⁴¹, Z⁴², Z⁴³, Z⁴⁴, and Z⁴⁵ are the same as the monovalent alkyl group that may have a substituent as R¹¹, R¹², R¹³, R²¹, R²², R²³, R²⁴, R³¹, R³², R³³, R³⁴, R³⁵, R⁴¹, R⁴², R⁴³, R⁴⁴, R⁴⁵, and R⁴⁶.

In General Formulae (1), (2), (3), and (4), X¹¹, X¹², X²¹, X²², X³¹, X³², X⁴¹, and X⁴² each independently represent a monovalent functional group selected from the group consisting of a succinic anhydride group, a (meth)acrylic group, an alicyclic epoxy group, an amino group, a hydroxyl group, and a glycidyl group.

The succinic anhydride group, the amino group, the hydroxyl group, and the glycidyl group each have the structures shown below. The (meth)acrylic group denotes an acrylic group or a methacrylic group, and each of the acrylic group and the methacrylic group has the structure shown below.

The alicyclic epoxy group is not limited as long as the alicyclic epoxy group is a monovalent group having an alicyclic structure and an epoxy group, and examples thereof include an alicyclic epoxy group (1) shown below. Further, examples thereof include, in addition to the following alicyclic epoxy group (1), an alicyclic epoxy group having an alicyclic structure with 3 or more and 20 or less carbon atoms, and the cyclic epoxy group may have an epoxy group in any place of the alicyclic structure.

Further, the monovalent groups shown below are linked at sites of “*”.

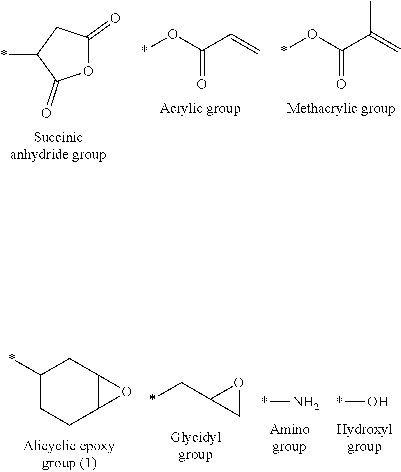

From the viewpoint of reducing the roughness of the outer peripheral surface of the photoreceptor, it is preferable that X¹¹, X¹², X²¹, X²², X³¹, X³², X⁴¹, and X⁴² each independently represent, for example, a monovalent functional group selected from the group consisting of a succinic anhydride group, a (meth)acrylic group, and an amino group.

In General Formulae (1), (2), (3), and (4), Y¹¹, Y¹², Y²¹, Y²², Y³¹, Y³², Y⁴¹, and Y⁴² each independently represent a divalent organic linking group. Further, the organic linking group denotes a divalent group having carbon atoms. Examples of the divalent organic linking group include a divalent alkyl group that may have a substituent. Examples of the divalent alkyl group that may have a substituent as Y¹¹, Y¹², Y²¹, Y²², Y³¹, Y³², Y⁴¹, and Y⁴² include a divalent group obtained by removing one hydrogen atom from a monovalent alkyl group that may have a substituent as R¹¹, R¹², R¹³, R²¹, R²², R²³, R²⁴, R³¹, R³², R³³, R³⁴, R³⁵, R⁴¹, R⁴², R⁴³, R⁴⁴, R⁴⁵, and R⁴⁶. Further, from the viewpoint of reducing the roughness of the outer peripheral surface of the photoreceptor, it is preferable that Y¹¹, Y¹², Y²¹, Y²², Y³¹, Y³², Y⁴¹, and Y⁴² each independently represent, for example, a divalent organic linking group represented by —(CH₂)ₙ— (for example, here, n represents preferably 1 or greater or 8 or less and more preferably 1 or greater and 6 or less).

From the viewpoint of reducing the roughness of the outer peripheral surface of the photoreceptor, for example, a cyclic siloxane compound represented by General Formula (2) is preferable as the cyclic siloxane compound contained in the outermost layer, and it is preferable that the outermost layer contains a total of 0.0010 ppm or greater of the cyclic siloxane compound represented by General Formula (2).

Further, from the viewpoint of reducing the roughness of the outer peripheral surface of the photoreceptor, for example, it is preferable that the cyclic siloxane compound represented by General Formula (2) contains two or four functional groups, that is, one or three of Z²¹, Z²², and Z²³ represent a group represented by —Y¹²—X¹². Further, it is preferable that the cyclic siloxane compound represented by General Formula (2) contains, for example, two functional groups. That is, it is more preferable that Z²² represents a group represented by —Y¹²—X¹² and Z²¹ and Z²³ represent a hydrogen atom or a monovalent alkyl group.

### Specific Examples of Cyclic Siloxane Compound

Specific examples of the cyclic siloxane compound include compounds No. 1 to No. 14 listed in the following table. Further, in the compounds No. 1 to No. 14, R's each independently represent a hydrogen atom or a monovalent alkyl group that may have a substituent, and n represents 1 or greater and 6 or less.

TABLE 1

| No. | Structure | X |
|---|---|---|
| 1 | (1) | Succinic anhydride |
| 2 | | Acrylic group |
| 3 | | Methacrylic group |
| 4 | | Alicyclic epoxy group (1) |
| 5 | | Glycidyl group |
| 6 | | Amino group |
| 7 | | Hydroxyl group |
| 8 | (2) | Succinic anhydride |
| 9 | | Acrylic group |
| 10 | | Methacrylic group |
| 11 | | Alicyclic epoxy group (1) |
| 12 | | Glycidyl group |
| 13 | | Amino group |
| 14 | | Hydroxyl group |

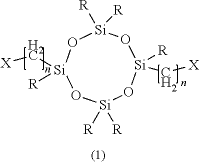

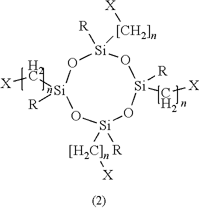

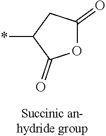 [SMILES: *C1CC(=O)OC1=O]

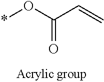 [SMILES: *OC(=O)C=C]

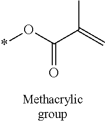 [SMILES: *OC(=O)C(=C)C]

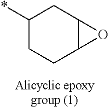 [SMILES: *C1CCC2OC2C1]

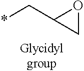 [SMILES: *CC1CO1]

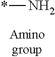 [SMILES: *N]

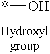 [SMILES: *O]

The outermost layer contains a total of 0.0010 ppm or greater of at least one selected from the group consisting of cyclic siloxane compounds represented by General Formulae (1), (2), (3), and (4). From the viewpoint of reducing the roughness of the outer peripheral surface of the photoreceptor, the total amount of the cyclic siloxane compound is, for example, preferably 0.005 ppm or greater and 20 ppm or less and more preferably 0.1 ppm or greater and 15 ppm or less.

From the viewpoint of suppressing degradation of the cleaning performance of the photoreceptor, the surface roughness Ra (arithmetic average surface roughness Ra) of the outer peripheral surface of the outermost layer is, for example, preferably 15 nm or less, more preferably 10 nm or less, and still more preferably 8 nm or less. Further, the lower limit of the surface roughness Ra may be 0 nm or greater or 1 nm or greater.

The surface roughness Ra (arithmetic average surface roughness Ra) is measured as follows.

A part of the outermost layer to be measured is cut out with a cutter or the like to acquire a measurement sample. The measurement is performed on this measurement sample using a stylus type surface roughness measuring machine (SURFCOM 1400A: manufactured by Tokyo Seimitsu Co., Ltd.). The measurement is performed in conformity with JIS B 0601-1994 under conditions of an evaluation length Ln of 2.5 mm, a reference length L of 0.8 mm, and a cutoff value of 0.008 mm.

Next, the layer configuration of the electrophotographic photoreceptor according to the present exemplary embodiment will be described with reference to the accompanying drawings.

In the drawings, the same or corresponding components are denoted by the same reference numerals, and overlapping description will be omitted.

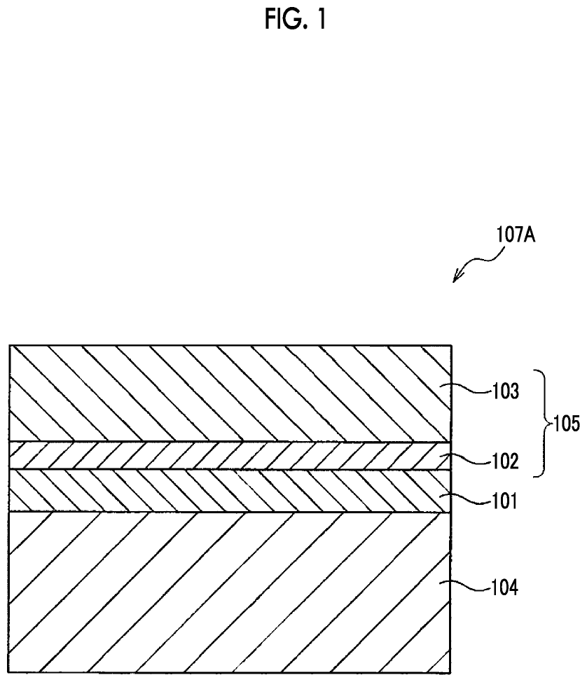

FIG. 1 is a schematic cross-sectional view showing an example of the layer configuration of the electrophotographic photoreceptor according to the present exemplary embodiment. A photoreceptor 107A has a structure in which an undercoat layer 101 is provided on a conductive substrate 104, and a charge generation layer 102 and a charge transport layer 103 are formed on the undercoat layer 101 in this order. The photoreceptor 107A includes an organic photosensitive layer 105 having functions separated into the charge generation layer 102 and the charge transport layer 103. Further, an interlayer may be provided between the conductive substrate 104 and the undercoat layer 101.

The charge transport layer 103 constitutes the outermost layer of the photoreceptor 107A. However, the present disclosure is not limited to this configuration, and the outermost layer of the photoreceptor may be, for example, a charge generation layer or an integrated organic photosensitive layer which is not functionally separated into the charge generation layer and the charge transport layer.

Hereinafter, each element constituting the electrophotographic photoreceptor will be described. Further, the reference numerals may be omitted in the description.

### Charge Transport Layer

The charge transport layer 103 constitutes the outermost layer of the photoreceptor 107A. Further, the charge transport layer 103 as the outermost layer contains a total of 0.0010 ppm or greater of at least one selected from the group consisting of cyclic siloxane compounds represented by General Formulae (1), (2), (3), and (4).

Hereinafter, the configurations of the charge transport layer other than the cyclic siloxane compound will be described.

The charge transport layer according to the present exemplary embodiment contains, for example, a binder resin and a charge transport material. The charge transport layer may further contain inorganic particles, fluorine-containing resin particles, known additives, and the like. The charge transport layer is provided on the charge generation layer described below.

### Charge Transport Material

Examples of the charge transport material include a quinone-based compound such as p-benzoquinone, chloranil, bromanil, or anthraquinone; a tetracyanoquinodimethane-based compound; a fluorenone compound such as 2,4,7-trinitrofluorenone; a xanthone-based compound; a benzophenone-based compound; a cyanovinyl-based compound; and an electron-transporting compound such as an ethylene-based compound.

Examples of the charge transport material include a positive hole-transporting compound such as a triarylamine-based compound, a benzidine-based compound, an arylalkane-based compound, an aryl-substituted ethylene-based compound, a stilbene-based compound, an anthracene-based compound, or a hydrazone-based compound.

It is preferable that the charge transport material contains, for example, at least one of a triarylamine derivative represented by Structural Formula (a-1) or a benzidine derivative represented by Structural Formula (a-2) as the charge transport material.

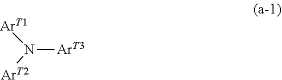

In Structural Formula (a-1), Ar^{T1}, Ar^{T2}, and Ar^{T3} each independently represent a substituted or unsubstituted aryl group, —C₆H₄—C(R^{T4})—C(R^{T5})(R^{T6}), or —C₆H₄—CH═CH—CH═C(R^{T7})(R^{T8}). R^{T4}, R^{T5}, R^{T6}, R^{T7}, and R^{T8} each independently represent a hydrogen atom, a substituted or unsubstituted alkyl group, or a substituted or unsubstituted aryl group.

Examples of the substituent of each group described above include a halogen atom, an alkyl group having 1 or more and 5 or less carbon atoms, and an alkoxy group having 1 or more and 5 or less carbon atoms. Further, examples of the substituent of each group described above include a substituted amino group substituted with an alkyl group having 1 or more and 3 or less carbon atoms.

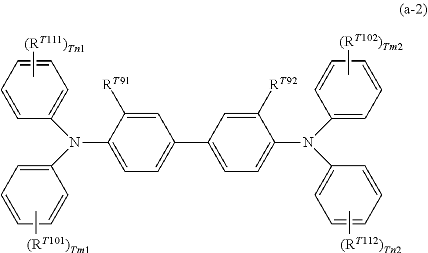

In Structural Formula (a-2), R^{T91} and R^{T92} each independently represent a hydrogen atom, a halogen atom, an alkyl group having 1 or more and 5 or less carbon atoms, or an alkoxy group having 1 or more and 5 or less carbon atoms. R^{T101}, R^{T102}, R^{T111}, and R^{T112} each independently represent a halogen atom, an alkyl group having 1 or more and 5 or less carbon atoms, an alkoxy group having 1 or more and 5 or less carbon atoms, a substituted amino group substituted with an alkyl group having 1 or more and 2 or less carbon atoms, a substituted or unsubstituted aryl group, —C(R^{T12})═C(R^{T13})(R^{T14}), or —CH═CH—CH═C(R^{T15})(R^{T16}), and R^{T12}, R^{T13}, R^{T14}, R^{T15}, and R^{T16} each independently represent a hydrogen atom, a substituted or unsubstituted alkyl group, or a substituted or unsubstituted aryl group. Tm1, Tm2, Tn1, and Tn2 each independently represent an integer of 0 or greater and 2 or less.

Examples of the substituent of each group described above include a halogen atom, an alkyl group having 1 or more and 5 or less carbon atoms, and an alkoxy group having 1 or more and 5 or less carbon atoms. Further, examples of the substituent of each group described above include a substituted amino group substituted with an alkyl group having 1 or more and 3 or less carbon atoms.

Among the triarylamine derivative represented by Structural Formula (a-1) and the benzidine derivative represented by Structural Formula (a-2), for example, a triarylamine derivative having “—C₆H₄—CH═CH—CH═C(R^{T7})(R^{T8})” and a benzidine derivative having “—CH═CH—CH═C(R^{T15})(R^{T16})” are particularly preferable.

The charge transport material contains, for example, preferably a charge transport material having a molecular weight of 850 or less, more preferably a charge transport material having a molecular weight of 50 or greater and 600 or less, and still more preferably a charge transport material having a molecular weight of 90 or greater and 550 or less, as the charge transport material.

Hereinafter, specific examples of the charge transport material will be described, but the charge transport material according to the present exemplary embodiment is not limited thereto.

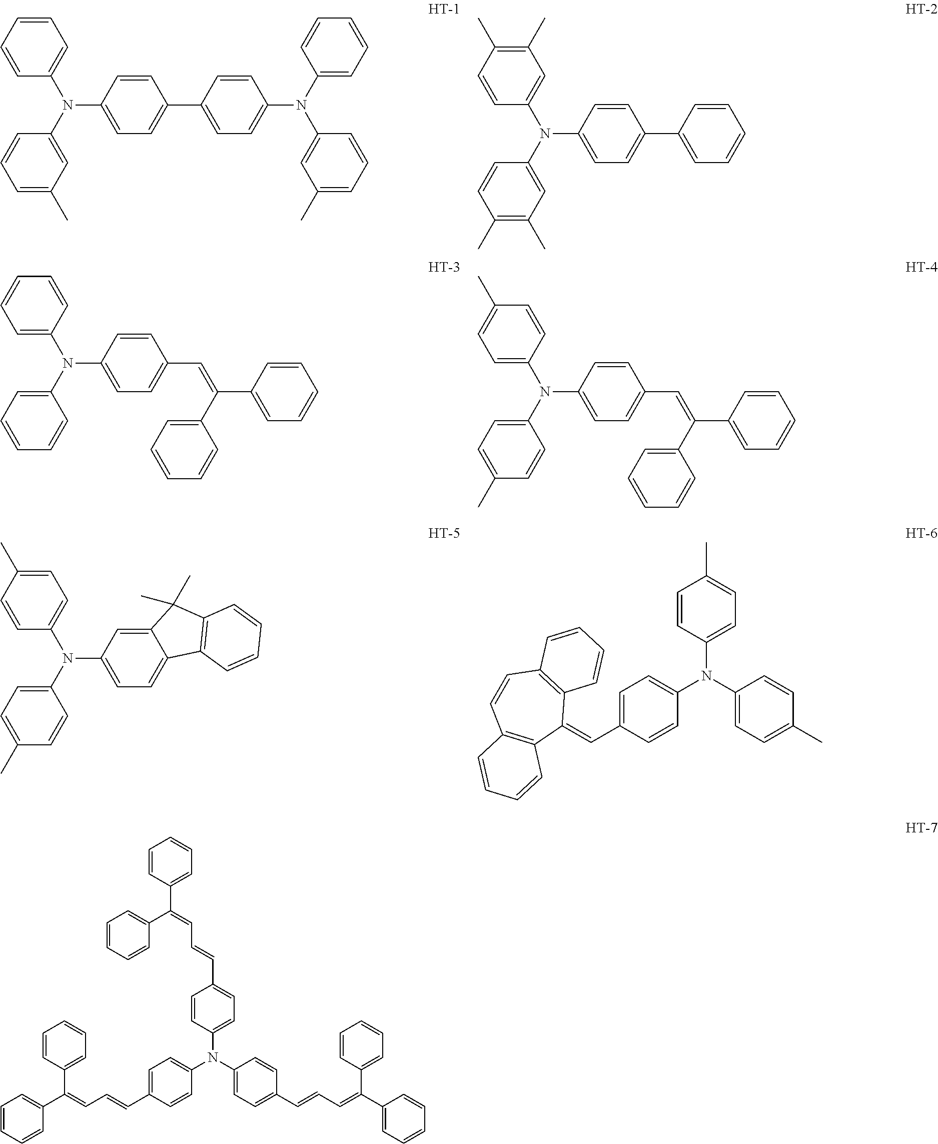

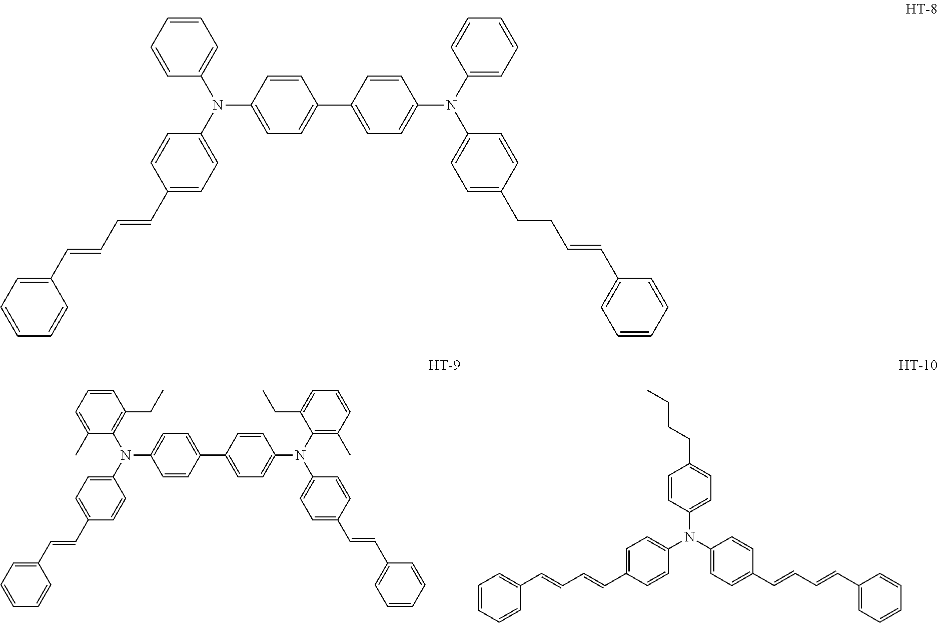 [SMILES: C(/C=C/c1ccc(N(c2ccccc2)c2ccc(-c3ccc(N(c4ccccc4)c4ccc(CC/C=C/c5ccccc5)cc4)cc3)cc2)cc1)=C\c1ccccc1 ; CCc1cccc(C)c1N(c1ccc(/C=C/c2ccccc2)cc1)c1ccc(-c2ccc(N(c3ccc(/C=C/c4ccccc4)cc3)c3c(C)cccc3CC)cc2)cc1 ; CCCCc1ccc(N(c2ccc(/C=C/C=C/c3ccccc3)cc2)c2ccc(/C=C/C=C/c3ccccc3)cc2)cc1]

For example, in a case where the charge transport layer contains, as the charge transport material, two kinds of materials, one selected from triarylamine derivatives represented by Structural Formula (a-1) and one selected from triarylamine derivatives represented by Structural Formula (a-2), the blending ratio between the two materials is not particularly limited, but the ratio (one selected from triarylamine derivatives represented by Structural Formula (a-1)/one selected from triarylamine derivatives represented by Structural Formula (a-2)) is, for example, preferably 10/1 or greater and 1/10 or less, more preferably 5/1 or greater and 1/5 or less, and still more preferably 2/1 or greater and 1/2 or less.

The content of the charge transport material in the charge transport layer according to the present exemplary embodiment is, for example, preferably 10% by mass or greater and 50% by mass or less and may be 20% by mass or greater and 40% by mass or less or 25% by mass or greater and 40% by mass or less with respect to the total amount of the charge transport material and the binder resin in the charge transport layer.

### Binder Resin

Specific examples of the binder resin include a polycarbonate resin (a homopolymer type such as bisphenol A, bisphenol Z, bisphenol C, or bisphenol TP, or a copolymer type thereof), a polyarylate resin, a polyester resin, a methacrylic resin, an acrylic resin, a polyvinyl chloride resin, a polyvinylidene chloride resin, a polystyrene resin, an acrylonitrile-styrene copolymer, an acrylonitrile-butadiene copolymer, a polyvinyl acetate resin, a styrene-butadiene copolymer, a vinyl chloride-vinyl acetate copolymer, a vinyl chloride-vinyl acetate-maleic anhydride copolymer, a silicone resin, a silicone-alkyd resin, a phenol-formaldehyde resin, a styrene-acrylic copolymer, an acetylene-alkyd resin, a poly-N-vinylcarbazole resin, a polyvinyl butyral resin, and a polyphenylene ether resin. The binder resins may be used alone or in combination of two or more kinds thereof.

Further, the blending ratio between the charge transport material and the binder resin is, for example, preferably in a range of 10:1 to 1:5 in terms of the mass ratio.

Among the binder resins described above, for example, a polycarbonate resin (a homopolymer type resin of bisphenol A, bisphenol Z, bisphenol C, or bisphenol TP, or a copolymer type resin thereof) is preferable. The polycarbonate resin may be used alone or in combination of two or more kinds thereof. From the same viewpoint as described above, among the polycarbonate resins, for example, a homopolymer type polycarbonate resin of bisphenol Z is more preferable.

The binder resin may have, for example, a viscosity average molecular weight of 50,000 or less. For example, the viscosity average molecular weight thereof may be 45,000 or less or 35,000 or less. The lower limit of the viscosity average molecular weight may be, for example, 20,000 or greater from the viewpoint of maintaining the characteristics of the binder resin.

The viscosity average molecular weight of the binder resin is measured by the following single-point measuring method.

First, the charge transport layer to be measured is exposed from the photoreceptor to be measured. Further, a part of the charge transport layer is scraped off to prepare a sample for measurement.

Next, a binder resin is extracted from the measurement sample. 1 g of the extracted binder resin is dissolved in 100 cm³ of methylene chloride, and a specific viscosity ηsp thereof is measured with an Ubbelohde viscometer in a measurement environment of 25° C. Thereafter, a limiting viscosity [η] (cm³/g) is acquired by the relational equation of “ηsp/c=[η]+0.45 [η]²c” (where c represents the concentration (g/cm³)), and a viscosity average molecular weight Mv is acquired by the relational equation of “[η]=1.23×10⁻⁴ Mv^{0.83}”, which is the equation provided by H. Schnell.

### Inorganic Particles

Examples of the inorganic particles include silica particles, alumina particles, titanium oxide particles, calcium carbonate particles, magnesium carbonate particles, tricalcium phosphate particles, and cerium oxide particles. The inorganic particles may be alone or in combination of two or more kinds thereof. Among the examples, it is preferable that the charge transport layer according to the present exemplary embodiment contains, for example, silica particles.

The content of the silica particles is, for example, preferably 90% by mass or greater and 100% by mass or less, more preferably 98% by mass or greater and 100% by mass or less, and still more preferably 100% by mass with respect to the total amount of the inorganic particles.

The content of the inorganic particles is, for example, preferably 30% by mass or greater and 70% by mass or less, more preferably 50% by mass or greater and 70% by mass or less, and still more preferably 60% by mass or greater and 70% by mass or less with respect to the total solid content of the charge transport layer.

The silica particles may be any of dry silica particles or wet silica particles.

Examples of the dry silica particles include silica by a combustion method (fumed silica) obtained by combustion of a silane compound and silica by a deflagration method obtained by explosive combustion of metallic silicon powder.

Examples of the wet silica particles include wet silica particles obtained by a neutralization reaction between sodium silicate and a mineral acid (silica by a precipitation method synthesized aggregated under alkaline conditions, silica particles by a gelation method synthesized aggregated under acidic conditions), colloidal silica particles obtained by alkalifying and polymerizing acidic silicic acid (silica sol particles), and silica particles by a sol-gel method obtained by the hydrolysis of an organic silane compound (for example, alkoxysilane).

Among these, from the viewpoint of suppressing generation of the residual potential, for example, combustion method silica particles having a small number of silanol groups on the surfaces and having a low void structure may be used as the silica particles.

The volume average particle diameter of the silica particles may be, for example, 20 nm or greater and 200 nm or less. The lower limit of the volume average particle diameter of the silica particles may be, for example, 40 nm or greater or 50 nm or greater. The lower limit of the volume average particle diameter of the silica particles may be, for example, 150 nm or less, 120 nm or less, or 110 nm or less.

The volume average particle diameter of the silica particles is acquired by separating the silica particles from the layer, observing 100 primary particles of the silica particles at a magnification of 40,000 times with a scanning electron microscope (SEM) device, and measuring the longest diameter and the shortest diameter of each particle by image analysis of primary particles, and measuring the sphere equivalent diameter from the median value. A 50% diameter (D50v) of the obtained sphere equivalent diameter in the cumulative frequency is acquired, and the acquired diameter is measured as the volume average particle diameter of the silica particles.

For example, the silica particles may have a surface subjected to a surface treatment with a hydrophobic treatment agent. In this manner, the number of silanol groups in the surface of the silica particles is reduced, and the occurrence of the residual potential is easily suppressed.

Examples of the hydrophobic treatment agent include known silane compounds such as chlorosilane, alkoxysilane, and silazane.

Among these, from the viewpoint of easily suppressing the generation of the residual potential, for example, a silane compound containing a trimethylsilyl group, a decylsilyl group, or a phenylsilyl group is preferable as the hydrophobic treatment agent. That is, for example, the surface of the silica particles may contain a trimethylsilyl group, a decylsilyl group, or a phenylsilyl group.

Examples of the silane compound containing a trimethylsilyl group include trimethylchlorosilane, trimethylmethoxysilane, and 1,1,1,3,3,3-hexamethyldisilazane.

Examples of the silane compound containing a decylsilyl group include decyltrichlorosilane, decyldimethylchlorosilane, and decyltrimethoxysilane.

Examples of the silane compound containing a phenyl group include triphenylmethoxysilane and triphenylchlorosilane.

The condensation ratio of silica particles subjected to a hydrophobic treatment (the proportion of Si—O—Si in a SiO₄— bond of the silica particles; hereinafter, also referred to as “condensation ratio of the hydrophobic treatment agent”) may be, for example, 90% or greater and is preferably 91% or greater and more preferably 95% or greater with respect to the silanol group in the surface of the silica particles. In a case where the condensation ratio of the hydrophobic treatment agent is in the above-described ranges, the amount of the silanol group of the silica particles is further reduced, and the generation of the residual potential is likely to be suppressed.

The condensation ratio of the hydrophobic treatment agent denotes the proportion of condensed silicon in a fully bondable site of silicon in a condensing portion detected by NMR, and is measured as follows. First, the silica particles are separated from the layer. The separated silica particles are subjected to Si CP/MAS NMR analysis with AVANCE III 400 (manufactured by Bruker), the peak area corresponding to the number of SiO substitutions is acquired, the values of two substitutions (Si(OH)₂(O—Si)₂—), three substitutions (Si(OH)(O—Si)₃—), and four substitutions (Si(O—Si)₄—) are defined as Q2, Q3, and Q4, and the condensation ratio of the hydrophobic treatment agent is calculated by the expression: (Q2×2+Q3×3+Q4×4)/4× (Q2+Q3+Q4).

The volume resistivity of the silica particles may be, for example, 10¹¹ Ωcm or greater and is preferably 10¹² Ωcm or greater and more preferably 10¹³ Ωcm or greater.

In a case where the volume resistivity of the silica particles is in the above-described ranges, the degradation of the electrical properties is suppressed.

The volume resistivity of the silica particles is measured as follows. The volume resistivity is measured in an environment at a temperature of 20° C. and a humidity of 50% RH.

First, the silica particles are separated from the layer. Further, separated silica particles to be measured are placed on the surface of a circular jig on which a 20 cm² electrode plate is disposed such that silica particles have a thickness of approximately 1 mm or greater and 3 mm or less, to form a silica particle layer. The same 20 cm² electrode plate as described above is placed on the silica particle layer such that the silica particle layer is sandwiched between the electrode plates. In order to eliminate voids between the silica particles, a load of 4 kg is applied to the electrode plate placed on the silica particle layer, and the thickness (cm) of the silica particle layer is measured. Both the upper and lower electrodes of the silica particle layer are connected to an electrometer and a high-voltage power supply device. The volume resistivity (Ωcm) of the silica particles is calculated by applying a high voltage to both electrodes such that the electric field reaches a predetermined value and reading a current value (A) flowing during the application of the voltage. The calculation equation for the volume resistivity (Ωcm) of the silica particles is as described below.

In the equation, p represents the volume resistivity (Ωcm) of the silica particles, E represents the applied voltage (V), I represents the current value (A), I₀ represents the current value (A) at an applied voltage 0V, and L represents the thickness (cm) of the silica particle layer. In the evaluation, the volume resistivity in a case where the applied voltage is 1,000 V is used.

$$\\ \begin{matrix}ρ = E \times 20 / ( I - {I}_{0} ) / L & Equation\end{matrix}$$

### Fluorine-Containing Resin Particles

As the fluorine-containing resin particles, for example, it is desirable that one or two or more kinds of particles are selected from among particles of a tetrafluoroethylene resin, a trifluoroethylene chloride resin, a hexafluoropropylene resin, a vinyl fluoride resin, a vinylidene fluoride resin, a difluoroethylene dichloride resin, and copolymers thereof. Among these, for example, tetrafluoroethylene resin particles and vinylidene fluoride resin particles are particularly desirable as the fluorine-containing resin particles.

The primary particle diameter of the fluorine-containing resin particles may be, for example, 0.05 μm or greater and 1 μm or less and is desirably 0.1 μm or greater and 0.5 μm or less.

Further, the primary particle diameter is an average value calculated by obtaining a sample piece from a photosensitive layer (charge transport layer), observing the sample piece with an SEM (scanning electron microscope) at a magnification of, for example, 5,000 times or greater, measuring the maximum diameter of the fluororesin particles in the primary particle state, performing the measurement on 50 particles, and averaging the measured values. Further, JSM-6700F (manufactured by JEOL, Ltd.) is used as the SEM, and a secondary electron image having an acceleration voltage of 5 kV is observed.

Examples of commercially available products of the fluororesin particles include LUBRON (registered trademark) series (manufactured by Daikin Industries, Ltd.), TEFLON (registered trademark) series (manufactured by DuPont), and DYNION (registered trademark) series (manufactured by Sumitomo 3M Ltd.).

The content of the fluorine-containing resin particles is, for example, preferably 1% by mass or greater and 30% by mass or less, more preferably 3% by mass or greater and 20% by mass or less, and still more preferably 5% by mass or greater and 15% by mass or less with respect to the total solid content of the photosensitive layer (charge transport layer).

The charge transport layer according to the present exemplary embodiment may further contain a fluorine-containing dispersant in addition to the fluorine-containing resin particles.

Next, the fluorine-containing dispersant will be described.

Examples of the fluorine-containing dispersant include a polymer obtained by homopolymerizing or copolymerizing a polymerizable compound containing an alkyl fluoride group (hereinafter, also referred to as “alkyl fluoride group-containing polymer”).

Specific examples of the fluorine-containing dispersant include a homopolymer of a (meth)acrylate containing an alkyl fluoride group, and a random or block copolymer of a (meth)acrylate containing an alkyl fluoride group and a monomer having no fluorine atom. Further, the (meth)acrylate denotes both an acrylate and a methacrylate.

Examples of the (meth)acrylate containing an alkyl fluoride group include 2,2,2-trifluoroethyl (meth)acrylate and 2,2,3,3,3-pentafluoropropyl (meth)acrylate.

Examples of the monomer having no fluorine atom include a (meth)acrylate, isobutyl (meth)acrylate, t-butyl (meth)acrylate, isooctyl (meth)acrylate, lauryl (meth)acrylate, stearyl (meth)acrylate, isobornyl (meth)acrylate, cyclohexyl (meth)acrylate, 2-methoxyethyl (meth)acrylate, methoxytriethylene glycol (meth)acrylate, 2-ethoxyethyl (meth)acrylate, tetrahydrofurfuryl (meth)acrylate, benzyl (meth)acrylate, ethylcarbitol (meth)acrylate, phenoxyethyl (meth)acrylate, 2-hydroxy (meth)acrylate, 2-hydroxypropyl (meth)acrylate, 4-hydroxybutyl (meth)acrylate, methoxypolyethylene glycol (meth)acrylate, phenoxypolyethylene glycol (meth)acrylate, hydroxyethyl o-phenylphenol (meth)acrylate, and o-phenylphenol glycidyl ether (meth)acrylate.

Further, specific examples of the fluorine-containing dispersant include the block polymers and branch polymers disclosed in U.S. Pat. No. 5,637,142, JP4251662B, and the like. Further, specific examples of the fluorine-containing dispersant also include a fluorine-based surfactant.

Among these, for example, an alkyl fluoride group-containing polymer having a structural unit represented by General Formula (FA) is preferable, and an alkyl fluoride group-containing polymer having a structural unit represented by General Formula (FA) and a structural unit represented by General Formula (FB) is more preferable as the fluorine-containing dispersant.

Hereinafter, the alkyl fluoride group-containing polymer having a structural unit represented by General Formula (FA) and a structural unit represented by General Formula (FB) will be described.

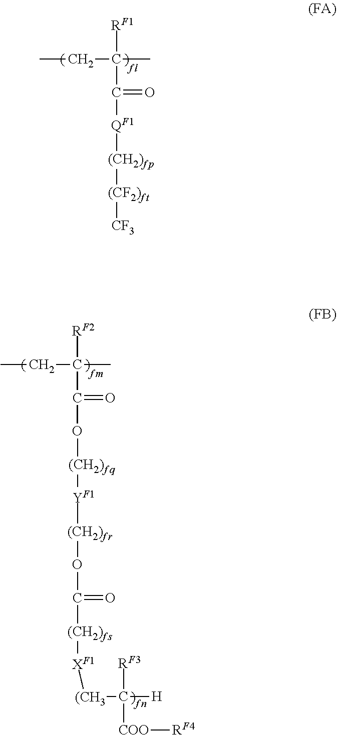

In General Formulae (FA) and (FB), R^{F1}, R^{F2}, R^{F3}, and R^{F4} each independently represent a hydrogen atom or an alkyl group.

X^{F1} represents an alkylene chain, a halogen-substituted alkylene chain, —S—, —O—, —NH—, or a single bond.

Y^{F1} represents an alkylene chain, a halogen-substituted alkylene chain, —(C_{fx}H_{2fx-1}(OH))—, or a single bond.

Q^{F1} represents —O— or —NH—.

fl, fm, and fn each independently represent an integer of 1 or greater.

fp, fq, fr, and fs each independently represent 0 or an integer of 1 or greater.

ft represents an integer of 1 or greater and 7 or less.

fx represents an integer of 1 or greater.

In General Formulae (FA) and (FB), R^{F1}, R^{F2}, R^{F3}, and R^{F4} represent, for example, preferably a hydrogen atom, a methyl group, an ethyl group, or a propyl group, more preferably a hydrogen atom or a methyl group, and still more preferably a methyl group.

In General Formulae (FA) and (FB), as the alkylene chain represented by X^{F1} and Y^{F1} (an unsubstituted alkylene chain or a halogen-substituted alkylene chain), for example, a linear or branched alkylene chain having 1 or more and 10 or less carbon atoms is preferable.

It is preferable that fx in —(C_{fx}H_{2fx-1}(OH))— represented by Y^{F1} represents, for example, an integer of 1 or greater and 10 or less.

It is preferable that fp, fq, fr, and fs each independently represent, for example, 0 or an integer of 1 or greater and 10 or less.

It is preferable that fn represents, for example, 1 or greater and 60 or less.

Here, in the fluorine-containing dispersant, the ratio of the structural unit represented by General Formula (FA) to the structural unit represented by General Formula (FB), that is, fl: fm is, for example, preferably in a range of 1:9 to 9:1 and more preferably in a range of 3:7 to 7:3.

Further, the fluorine-containing dispersant may further have a structural unit represented by General Formula (FC) in addition to the structural unit represented by General Formula (FA) and the structural unit represented by General Formula (FB). The content ratio of the total content of the structural units represented by General Formulae (FA) and (FB), that is, fl+fm to the content of the structural unit represented by General Formula (FC) (fl+fm:fz) is, for example, preferably in a range of 10:0 to 7:3 and more preferably in a range of 9:1 to 7:3.

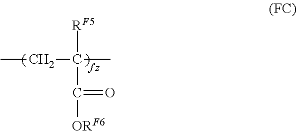

In General Formula (FC), R^{F5} and R^{F6} each independently represent a hydrogen atom or an alkyl group. fz represents an integer of 1 or greater.

In General Formula (FC), R^{F5} and R^{F6} represent, for example, preferably a hydrogen atom, a methyl group, an ethyl group, or a propyl group, more preferably a hydrogen atom or a methyl group, and still more preferably a methyl group.

Examples of commercially available products of the fluorine-containing dispersants include GF300 and GF400 (manufactured by Toagosei Co., Ltd.), SURFLON (registered trademark) series (manufactured by AGC Seimi Chemical Co., Ltd.), FTERGENT series (manufactured by Neos Corporation), PF series (manufactured by Kitamura Chemicals Co., Ltd.), MEGAFACE (registered trademark) series (manufactured by DIC Corporation), and FC series (manufactured by 3M Company).

The weight-average molecular weight of the fluorine-containing dispersant is, for example, preferably 2,000 or greater and 250,000 or less, more preferably 3,000 or greater and 150,000 or less, and still more preferably 50,000 or greater and 100,000 or less.

The weight-average molecular weight of the fluorine-containing dispersant is a value measured by gel permeation chromatography (GPC). The molecular weight is measured according to GPC, for example, by performing calculation with a chloroform solvent and a molecular weight calibration curve prepared by a monodisperse polystyrene standard sample from the measurement result using a GPC HLC-8120 (manufactured by Tosoh Corporation) as a measuring device and TSKgel GMHHR-M+TSKgel GMHHR-M (7.8 mm I.D. 30 cm) (manufactured by Tosoh Corporation) as columns.

The content of the alkyl fluoride group-containing polymer is, for example, preferably 0.5% by mass or greater and 10% by mass or less and more preferably 1% by mass or greater and 7% by mass or less with respect to the mass of the fluorine-containing resin particles.

Further, the alkyl fluoride group-containing polymer may be used alone or in combination of two or more kinds thereof.

### Formation of Charge Transport Layer

The formation of the charge transport layer is not particularly limited, and a known forming method is used. For example, a coating film of a coating solution for forming a charge transport layer in which the above-described components are added to a solvent is formed, and the coating film is dried and, as necessary, heated.

Examples of the solvent for preparing the coating solution for forming a charge transport layer include typical organic solvents, for example, aromatic hydrocarbons such as benzene, toluene, xylene, and chlorobenzene; ketones such as acetone and 2-butanone; halogenated aliphatic hydrocarbons such as methylene chloride, chloroform, and ethylene chloride; and cyclic or linear ethers such as tetrahydrofuran and ethyl ether. These solvents are used alone or in the form of a mixture of two or more kinds thereof.

Examples of the coating method of coating the charge generation layer with the coating solution for forming a charge transport layer include typical methods such as a blade coating method, a wire bar coating method, a spray coating method, a dip coating method, a bead coating method, an air knife coating method, and a curtain coating method.

Further, in a case where particles (for example, silica particles or fluororesin particles) are dispersed in the coating solution for forming a charge transport layer, as a dispersing method, for example, a media disperser such as a ball mill, a vibration ball mill, an attritor, a sand mill, or a horizontal sand mill, or a medialess disperser such as a stirrer, an ultrasonic disperser, a roll mill, or a high-pressure homogenizer is used. Examples of the high-pressure homogenizer include a collision type high-pressure homogenizer in which a dispersion liquid is dispersed by a liquid-liquid collision or a liquid-wall collision in a high-pressure state, and a penetration type high-pressure homogenizer in which dispersion is performed by causing a dispersion liquid to pass through a fine flow path in a high-pressure state.

### Conductive Substrate

Examples of the conductive substrate include metal plates containing metals (such as aluminum, copper, zinc, chromium, nickel, molybdenum, vanadium, indium, gold, and platinum) or alloys (such as stainless steel), metal drums, metal belts, and the like. Further, examples of the conductive substrate include paper, a resin film, a belt, and the like obtained by being coated, vapor-deposited or laminated with a conductive compound (such as a conductive polymer or indium oxide), a metal (such as aluminum, palladium, or gold) or an alloy. Here, the term “conductive” denotes that the volume resistivity is less than 10¹³ Ωcm.

In a case where the electrophotographic photoreceptor is used in a laser printer, for example, it is preferable that the surface of the conductive substrate is roughened such that a centerline average roughness Ra thereof is 0.04 μm or greater and 0.5 μm or less for the purpose of suppressing interference fringes from occurring in a case of irradiation with laser beams. Further, in a case where incoherent light is used as a light source, roughening of the surface to prevent interference fringes is not particularly necessary, and roughening of the surface to prevent interference fringes is appropriate for longer life because occurrence of defects due to the roughness of the surface of the conductive substrate is suppressed.

Examples of the roughening method include wet honing performed by suspending an abrasive in water and spraying the suspension to the conductive substrate, centerless grinding performed by pressure-welding the conductive substrate against a rotating grindstone and continuously grinding the conductive substrate, and an anodizing treatment.

Examples of the roughening method also include a method of dispersing conductive or semi-conductive powder in a resin without roughening the surface of the conductive substrate to form a layer on the surface of the conductive substrate, and performing roughening using the particles dispersed in the layer.

The roughening treatment performed by anodization is a treatment of forming an oxide film on the surface of the conductive substrate by carrying out anodization in an electrolytic solution using a conductive substrate made of a metal (for example, aluminum) as an anode. Examples of the electrolytic solution include a sulfuric acid solution and an oxalic acid solution. However, a porous anodized film formed by anodization is chemically active in a natural state, is easily contaminated, and has a large resistance fluctuation depending on the environment. Therefore, for example, it is preferable that a sealing treatment is performed on the porous anodized film so that the fine pores of the oxide film are closed by volume expansion due to a hydration reaction in pressurized steam or boiling water (a metal salt such as nickel may be added thereto) for a change into a more stable a hydrous oxide.

The film thickness of the anodized film is, for example, preferably 0.3 μm or greater and 15 μm or less. In a case where the film thickness is in the above-described range, the barrier properties against injection tend to be exhibited, and an increase in the residual potential due to repeated use tends to be suppressed.

The conductive substrate may be subjected to a treatment with an acidic treatment liquid or a boehmite treatment.

The treatment with an acidic treatment liquid is carried out, for example, as follows. First, an acidic treatment liquid containing phosphoric acid, chromic acid, and hydrofluoric acid is prepared. In the blending ratio of phosphoric acid, chromic acid, and hydrofluoric acid to the acidic treatment liquid, for example, the concentration of the phosphoric acid is 10% by mass or greater and 11% by mass or less, the concentration of the chromic acid is 3% by mass or greater and 5% by mass or less, and the concentration of the hydrofluoric acid is 0.5% by mass or greater and 2% by mass or less, and the concentration of all these acids may be 13.5% by mass or greater and 18% by mass or less. The treatment temperature is, for example, preferably 42° C. or higher and 48° C. or lower. The film thickness of the coating film is, for example, preferably 0.3 μm or greater and 15 μm or less.

The boehmite treatment is carried out, for example, by immersing the conductive substrate in pure water at 90° C. or higher and 100° C. or lower for 5 minutes to 60 minutes or by bringing the conductive substrate into contact with heated steam at 90° C. or higher and 120° C. or lower for 5 minutes to 60 minutes. The film thickness of the coating film is, for example, preferably 0.1 μm or greater and 5 μm or less. This coating film may be further subjected to the anodizing treatment using an electrolytic solution having low film solubility, such as adipic acid, boric acid, a borate, a phosphate, a phthalate, a maleate, a benzoate, a tartrate, or a citrate.

### Undercoat Layer

The undercoat layer may be, for example, a layer containing inorganic particles and a binder resin or a layer consisting of a metal oxide.

### Layer Containing Inorganic Particles And Resin Particles

Examples of the inorganic particles in the layer containing inorganic particles and resin particles include inorganic particles having a powder resistance (volume resistivity) of 10² Ωcm or greater and 10¹¹ Ωcm or less.

Among these, as the inorganic particles having the above-described resistance value, for example, metal oxide particles such as tin oxide particles, titanium oxide particles, zinc oxide particles, and zirconium oxide particles may be used, and zinc oxide particles are particularly preferable.

The specific surface area of the inorganic particles measured by the BET method may be, for example, 10 m²/g or greater.

The volume average particle diameter of the inorganic particles may be, for example, 50 nm or greater and 2,000 nm or less (for example, preferably 60 nm or greater and 1,000 nm or less).

The content of the inorganic particles is, for example, preferably 10% by mass or greater and 80% by mass or less and more preferably 40% by mass or greater and 80% by mass or less with respect to the amount of the binder resin.

The inorganic particles may be subjected to a surface treatment. As the inorganic particles, inorganic particles subjected to different surface treatments or inorganic particles having different particle diameters may be used in the form of a mixture of two or more kinds thereof.

Examples of the surface treatment agent include a silane coupling agent, a titanate-based coupling agent, an aluminum-based coupling agent, and a surfactant. In particular, for example, a silane coupling agent is preferable, and a silane coupling agent containing an amino group is more preferable.

Examples of the silane coupling agent containing an amino group include 3-aminopropyltriethoxysilane, N-2-(aminoethyl)-3-aminopropyltrimethoxysilane, N-2-(aminoethyl)-3-aminopropylmethyldimethoxysilane, and N,N-bis (2-hydroxyethyl)-3-aminopropyltriethoxysilane, but are not limited thereto.

The silane coupling agent may be used in the form of a mixture of two or more kinds thereof. For example, a silane coupling agent containing an amino group and another silane coupling agent may be used in combination. Examples of other silane coupling agents include vinyltrimethoxysilane, 3-methacryloxypropyl-tris (2-methoxyethoxy) silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis (2-hydroxyethyl)-3-aminopropyltriethoxysilane, and 3-chloropropyltrimethoxysilane, but are not limited thereto.

The surface treatment method using a surface treatment agent may be any method as long as the method is a known method, and any of a dry method or a wet method may be used.

The treatment amount of the surface treatment agent is, for example, preferably 0.5% by mass or greater and 10% by mass or less with respect to the amount of the inorganic particles.

Here, in a case where the undercoat layer is a layer containing inorganic particles and resin particles, the undercoat layer may contain, for example, an electron-accepting compound (acceptor compound) together with the inorganic particles from the viewpoint of enhancing the long-term stability of the electrical properties and the carrier blocking properties.

Examples of the electron-accepting compound include electron-transporting substances, for example, a quinone-based compound such as chloranil or bromanil; a tetracyanoquinodimethane-based compound; a fluorenone compound such as 2,4,7-trinitrofluorenone or 2,4,5,7-tetranitro-9-fluorenone; an oxadiazole-based compound such as 2-(4-biphenyl)-5-(4-t-butylphenyl)-1,3,4-oxadiazole, 2,5-bis (4-naphthyl)-1,3,4-oxadiazole, or 2,5-bis (4-diethylaminophenyl)-1,3,4-oxadiazole; a xanthone-based compound; a thiophene compound; and a diphenoquinone compound such as 3,3′,5,5′-tetra-t-butyldiphenoquinone.

In particular, as the electron-accepting compound, for example, a compound having an anthraquinone structure is preferable. As the compound having an anthraquinone structure, for example, a hydroxyanthraquinone compound, an aminoanthraquinone compound, or an aminohydroxyanthraquinone compound is preferable, and specifically, for example, anthraquinone, alizarin, quinizarin, anthrarufin, or purpurin is preferable.

The electron-accepting compound may be contained in the undercoat layer in a state of being dispersed with inorganic particles or in a state of being attached to the surface of each inorganic particle.

Examples of the method of attaching the electron-accepting compound to the surface of the inorganic particle include a dry method and a wet method.

The dry method is, for example, a method of attaching the electron-accepting compound to the surface of each inorganic particle by adding the electron-accepting compound dropwise to inorganic particles directly or by dissolving the electron-accepting compound in an organic solvent while stirring the inorganic particles with a mixer having a large shearing force and spraying the mixture together with dry air or nitrogen gas. The electron-accepting compound may be added dropwise or sprayed, for example, at a temperature lower than or equal to the boiling point of the solvent. After the dropwise addition or the spraying of the electron-accepting compound, the compound may be further baked at 100° C. or higher. The baking is not particularly limited as long as the temperature and the time are adjusted such that the electrophotographic characteristics can be obtained.

The wet method is, for example, a method of attaching the electron-accepting compound to the surface of each inorganic particle by adding the electron-accepting compound to inorganic particles while dispersing the inorganic particles in a solvent using a stirrer, ultrasonic waves, a sand mill, an attritor, or a ball mill, stirring or dispersing the mixture, and removing the solvent. The solvent removing method is carried out by, for example, filtration or distillation so that the solvent is distilled off. After removal of the solvent, the mixture may be further baked at 100° C. or higher. The baking is not particularly limited as long as the temperature and the time are adjusted such that the electrophotographic characteristics can be obtained. In the wet method, the moisture contained in the inorganic particles may be removed before the electron-accepting compound is added, and examples thereof include a method of removing the moisture while stirring and heating the moisture in a solvent and a method of removing the moisture by azeotropically boiling the moisture with a solvent.

Further, the electron-accepting compound may be attached to the surface before or after the inorganic particles are subjected to a surface treatment with a surface treatment agent or simultaneously with the surface treatment performed on the inorganic particles with a surface treatment agent.

The content of the electron-accepting compound may be, for example, 0.01% by mass or greater and 20% by mass or less and preferably 0.01% by mass or greater and 10% by mass or less with respect to the amount of the inorganic particles.

In a case where the undercoat layer is a layer containing inorganic particles and resin particles, examples of the binder resin used for the undercoat layer include known polymer compounds such as an acetal resin (such as polyvinyl butyral), a polyvinyl alcohol resin, a polyvinyl acetal resin, a casein resin, a polyamide resin, a cellulose resin, gelatin, a polyurethane resin, a polyester resin, an unsaturated polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a urea resin, a phenol resin, a phenol-formaldehyde resin, a melamine resin, a urethane resin, an alkyd resin, and an epoxy resin, a zirconium chelate compound, a titanium chelate compound, an aluminum chelate compound, a titanium alkoxide compound, an organic titanium compound, and known materials such as a silane coupling agent.

Examples of the binder resin used for the undercoat layer include a charge-transporting resin containing a charge-transporting group, and a conductive resin (such as polyaniline).

Among these, as the binder resin used for the undercoat layer, for example, a resin insoluble in a coating solvent of the upper layer is preferable, and a resin obtained by reaction between a curing agent and at least one resin selected from the group consisting of a thermosetting resin such as a urea resin, a phenol resin, a phenol-formaldehyde resin, a melamine resin, a urethane resin, an unsaturated polyester resin, an alkyd resin, or an epoxy resin; a polyamide resin, a polyester resin, a polyether resin, a methacrylic resin, an acrylic resin, a polyvinyl alcohol resin, and a polyvinyl acetal resin is particularly preferable.

In a case where these binder resins are used in combination of two or more kinds thereof, the mixing ratio thereof is set as necessary.

The undercoat layer may contain various additives for improving the electrical properties, the environmental stability, and the image quality.

Examples of the additives include known materials, for example, an electron-transporting pigment such as a polycyclic condensed pigment or an azo-based pigment, a zirconium chelate compound, a titanium chelate compound, an aluminum chelate compound, a titanium alkoxide compound, an organic titanium compound, and a silane coupling agent. The silane coupling agent is used for a surface treatment of the inorganic particles as described above, but may be further added to the undercoat layer as an additive.

Examples of the silane coupling agent serving as an additive include vinyltrimethoxysilane, 3-methacryloxypropyl-tris (2-methoxyethoxy) silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis (2-hydroxyethyl)-3-aminopropyltriethoxysilane, and 3-chloropropyltrimethoxysilane.

Examples of the zirconium chelate compound include zirconium butoxide, ethyl zirconium acetoacetate, zirconium triethanolamine, acetylacetonate zirconium butoxide, ethyl zirconium butoxide acetoacetate, zirconium acetate, zirconium oxalate, zirconium lactate, zirconium phosphonate, zirconium octanoate, zirconium naphthenate, zirconium laurate, zirconium stearate, zirconium isostearate, zirconium butoxide methacrylate, stearate zirconium butoxide, and isostearate zirconium butoxide.

Examples of the titanium chelate compound include tetraisopropyl titanate, tetranormal butyl titanate, a butyl titanate dimer, tetra (2-ethylhexyl) titanate, titanium acetylacetonate, polytitanium acetylacetonate, titanium octylene glycolate, titanium lactate ammonium salt, titanium lactate, titanium lactate ethyl ester, titanium triethanol aminate, and polyhydroxy titanium stearate.

Examples of the aluminum chelate compound include aluminum isopropylate, monobutoxyaluminum diisopropylate, aluminum butyrate, diethylacetoacetate aluminum diisopropylate, and aluminum tris (ethylacetoacetate).

These additives may be used alone or in the form of a mixture or a polycondensate of a plurality of compounds.

In a case where the undercoat layer is a layer containing inorganic particles and resin particles, the undercoat layer may have, for example, a Vickers hardness of 35 or greater.

The surface roughness (ten-point average roughness) of the undercoat layer may be adjusted, for example, to 1/2 from 1/(4n) (n represents a refractive index of an upper layer) of a laser wavelength λ for exposure to be used to suppress moire fringes.

Resin particles or the like may be added to the undercoat layer to adjust the surface roughness. Examples of the resin particles include silicone resin particles and crosslinked polymethyl methacrylate resin particles. Further, the surface of the undercoat layer may be polished to adjust the surface roughness. Examples of the polishing method include buff polishing, a sandblast treatment, wet honing, and a grinding treatment.

In a case where the undercoat layer is a layer containing inorganic particles and resin particles, the formation of the undercoat layer is not particularly limited, and a known forming method is used. For example, a coating film of a coating solution for forming an undercoat layer in which the above-described components are added to a solvent is formed, and the coating film is dried and, as necessary, heated.

Examples of the solvent for preparing the coating solution for forming an undercoat layer include known organic solvents such as an alcohol-based solvent, an aromatic hydrocarbon solvent, a halogenated hydrocarbon solvent, a ketone-based solvent, a ketone alcohol-based solvent, an ether-based solvent, and an ester-based solvent.

Specific examples of these solvents include typical organic solvents such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

Examples of the method of dispersing the inorganic particles in a case of preparing the coating solution for forming an undercoat layer include known methods such as a roll mill, a ball mill, a vibration ball mill, an attritor, a sand mill, a colloid mill, and a paint shaker.

Examples of the method of coating the conductive substrate with the coating solution for forming an undercoat layer include typical coating methods such as a blade coating method, a wire bar coating method, a spray coating method, a dip coating method, a bead coating method, an air knife coating method, and a curtain coating method.

In a case where the undercoat layer is a layer containing inorganic particles and resin particles, the film thickness of the undercoat layer is, for example, set to preferably 15 μm or greater and more preferably 20 μm or greater and 50 μm or less.

### Layer Consisting of Metal Oxide Layer

An undercoat layer that is a layer consisting of a metal oxide denotes a layered material of a metal oxide (for example, a CVD film formed of a metal oxide, a vapor deposition film formed of a metal oxide, or a sputtering film formed of a metal oxide), and aggregates or bulk materials of metal oxide particles are excluded.

As the undercoat layer consisting of a metal oxide layer, for example, a metal oxide layer consisting of a metal oxide containing a group 13 element and oxygen is preferable from the viewpoints of excellent mechanical strength, light transmitting properties, and conductivity.

Examples of the metal oxide containing a group 13 element and oxygen include metal oxides such as gallium oxide, aluminum oxide, indium oxide, and boron oxide, and mixed crystals thereof.

Among these, as the metal oxide containing a group 13 element and oxygen, for example, gallium oxide is particularly preferable from the viewpoints of excellent mechanical strength and light transmitting properties, particularly n-type conductivity, and excellent conductivity controllability.

That is, it is preferable that the layer consisting of a metal oxide is, for example, a metal oxide layer containing gallium and oxygen.

As the undercoat layer consisting of a metal oxide layer, for example, a layer consisting of a metal oxide containing a group 13 element (for example, preferably gallium) and oxygen is preferable, but a layer containing hydrogen and carbon atoms may be used as necessary.

The undercoat layer consisting of a metal oxide layer may be a layer further containing zinc (Zn).

Further, the undercoat layer consisting of a metal oxide layer may contain other elements for conductive type control. The undercoat layer consisting of a metal oxide layer may contain one or more elements selected from C, Si, Ge, and Sn in a case of an n-type and may contain one or more elements selected from N, Be, Mg, Ca, and Sr in a case of a p-type for conductive type control.

In particular, the undercoat layer consisting of a metal oxide layer contains, for example, a group 13 element, oxygen, and hydrogen, and the sum of the element composition ratio of the group 13 element, the oxygen, and the hydrogen to all the elements constituting the undercoat layer consisting of a metal oxide layer is preferably 90 atomic % or greater.

The undercoat layer consisting of a metal oxide layer is formed, for example, by known vapor phase film deposition methods such as a plasma chemical vapor deposition (CVD) method, an organic metal vapor phase growth method, a molecular beam epitaxy method, vapor deposition, and sputtering.

The thickness of the undercoat layer consisting of a metal oxide layer is, for example, preferably 0.1 μm or greater and 10 μm or less, more preferably 0.2 μm or greater and 8.0 μm or less, and still more preferably 0.5 μm or greater and 5.0 μm or less.

### Interlayer

Although not shown in the figures, an interlayer may be further provided between the undercoat layer and the photosensitive layer.

The interlayer is, for example, a layer containing a resin. Examples of the resin used for the interlayer include a polymer compound, for example, an acetal resin (such as polyvinyl butyral), a polyvinyl alcohol resin, a polyvinyl acetal resin, a casein resin, a polyamide resin, a cellulose resin, gelatin, a polyurethane resin, a polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a phenol-formaldehyde resin, or a melamine resin.

The interlayer may be a layer containing an organometallic compound. Examples of the organometallic compound used for the interlayer include an organometallic compound containing metal atoms such as zirconium, titanium, aluminum, manganese, and silicon.

The compounds used for the interlayer may be used alone or in the form of a mixture or a polycondensate of a plurality of compounds.

Among these, it is preferable that the interlayer is, for example, a layer containing an organometallic compound having a zirconium atom or a silicon atom.

The formation of the interlayer is not particularly limited, and a known forming method is used. For example, a coating film of a coating solution for forming an interlayer in which the above-described components are added to a solvent is formed, and the coating film is dried and, as necessary, heated.

Examples of the coating method of forming the interlayer include typical coating methods such as a dip coating method, a push-up coating method, a wire bar coating method, a spray coating method, a blade coating method, an air knife coating method, and a curtain coating method.

The film thickness of the interlayer is set to be, for example, preferably in a range of 0.1 μm or greater and 3 μm or less. Further, the interlayer may be used as the undercoat layer.

### Charge Generation Layer

The charge generation layer is, for example, a layer containing a charge generation material and a binder resin. Further, the charge generation layer may be a deposition layer of the charge generation material. The deposition layer of the charge generation material is, for example, preferable in a case where an incoherent light source such as a light emitting diode (LED) or an organic electroluminescence (EL) image array is used.

Examples of the charge generation material include an azo pigment such as bisazo or trisazo; a fused ring aromatic pigment such as dibromoanthanthrone; a perylene pigment; a pyrrolopyrrole pigment; a phthalocyanine pigment; zinc oxide; and trigonal selenium.

Among these, for example, a metal phthalocyanine pigment or a metal-free phthalocyanine pigment is preferably used as the charge generation material in order to deal with laser exposure in a near infrared region. Specifically, for example, hydroxygallium phthalocyanine, chlorogallium phthalocyanine, dichloro-tin phthalocyanine, and titanyl phthalocyanine are more preferable.

On the other hand, for example, a fused ring aromatic pigment such as dibromoanthanthrone, a thioindigo-based pigment, a porphyrazine compound, zinc oxide, trigonal selenium, or a bisazo pigment is preferable as the charge generation material in order to deal with laser exposure in a near ultraviolet region.

The above-described charge generation material may also be used even in a case where an incoherent light source such as an LED or an organic EL image array having a center wavelength of light emission at 450 nm or greater and 780 nm or less is used, but from the viewpoint of the resolution, the field intensity in the photosensitive layer is increased, and a decrease in charge due to injection of a charge from the substrate, that is, image defects referred to as so-called black spots are likely to occur in a case where a thin film having a thickness of 20 μm or less is used as the photosensitive layer. The above-described tendency is evident in a case where a p-type semiconductor such as trigonal selenium or a phthalocyanine pigment is used as the charge generation material that is likely to generate a dark current.

On the other hand, in a case where an n-type semiconductor such as a fused ring aromatic pigment, a perylene pigment, or an azo pigment is used as the charge generation material, a dark current is unlikely to be generated, and image defects referred to as black spots can be suppressed even in a case where a thin film is used as the photosensitive layer.

Further, the n-type is determined by the polarity of the flowing photocurrent using a typically used time-of-flight method, and a material in which electrons more easily flow as carriers than positive holes is determined as the n-type.

The binder resin used for the charge generation layer is selected from a wide range of insulating resins, and the binder resin may be selected from organic photoconductive polymers such as poly-N-vinylcarbazole, polyvinylanthracene, polyvinylpyrene, and polysilane.

Examples of the binder resin include a polyvinyl butyral resin, a polyarylate resin (a polycondensate of bisphenols and aromatic divalent carboxylic acid), a polycarbonate resin, a polyester resin, a phenoxy resin, a vinyl chloride-vinyl acetate copolymer, a polyamide resin, an acrylic resin, a polyacrylamide resin, a polyvinylpyridine resin, a cellulose resin, a urethane resin, an epoxy resin, casein, a polyvinyl alcohol resin, and a polyvinylpyrrolidone resin. Here, the term “insulating” denotes that the volume resistivity is 10¹³ Ωcm or greater.

These binder resins may be used alone or in the form of a mixture of two or more kinds thereof.

Further, the blending ratio between the charge generation material and the binder resin is, for example, preferably in a range of 10:1 to 1:10 in terms of the mass ratio.

The charge generation layer may also contain other known additives.

The formation of the charge generation layer is not particularly limited, and a known forming method is used. For example, a coating film of a coating solution for forming a charge generation layer in which the above-described components are added to a solvent is formed, and the coating film is dried and, as necessary, heated. Further, the charge generation layer may be formed by vapor deposition of the charge generation material. The formation of the charge generation layer by vapor deposition is, for example, particularly appropriate in a case where a fused ring aromatic pigment or a perylene pigment is used as the charge generation material.

Examples of the solvent for preparing the coating solution for forming a charge generation layer include methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, and toluene. These solvents are used alone or in the form of a mixture of two or more kinds thereof.

As a method of dispersing particles (for example, the charge generation material) in the coating solution for forming a charge generation layer, for example, a media disperser such as a ball mill, a vibration ball mill, an attritor, a sand mill, or a horizontal sand mill, or a medialess disperser such as a stirrer, an ultrasonic disperser, a roll mill, or a high-pressure homogenizer is used. Examples of the high-pressure homogenizer include a collision type high-pressure homogenizer in which a dispersion liquid is dispersed by a liquid-liquid collision or a liquid-wall collision in a high-pressure state, and a penetration type high-pressure homogenizer in which dispersion is performed by causing a dispersion liquid to pass through a micro-flow path in a high-pressure state.

During the dispersion, it is effective to set the average particle diameter of the charge generation material in the coating solution for forming a charge generation layer to 0.5 μm or less, for example, preferably 0.3 μm or less, and more preferably 0.15 μm or less.

Examples of the method of coating the undercoat layer (or the interlayer) with the coating solution for forming a charge generation layer include typical methods such as a blade coating method, a wire bar coating method, a spray coating method, a dip coating method, a bead coating method, an air knife coating method, and a curtain coating method.

The film thickness of the charge generation layer is set to be, for example, preferably in a range of 0.1 μm or greater and 5.0 μm or less and more preferably in a range of 0.15 μm or greater and 2.0 μm or less.

### Image Forming Apparatus (and Process Cartridge)

An image forming apparatus according to the present exemplary embodiment includes the electrophotographic photoreceptor, a charging unit that charges a surface of the electrophotographic photoreceptor, an electrostatic latent image forming unit that forms an electrostatic latent image on the charged surface of the electrophotographic photoreceptor, a developing unit that develops the electrostatic latent image formed on the surface of the electrophotographic photoreceptor with a developer containing a toner to form a toner image, and a transfer unit that transfers the toner image to a surface of a recording medium. Further, the electrophotographic photoreceptor according to the present exemplary embodiment is employed as the electrophotographic photoreceptor.

As the image forming apparatus according to the present exemplary embodiment, known image forming apparatuses such as an apparatus including a fixing unit that fixes the toner image transferred to the surface of a recording medium; a direct transfer type apparatus that transfers the toner image formed on the surface of the electrophotographic photoreceptor directly to the recording medium; an intermediate transfer type apparatus that primarily transfers the toner image formed on the surface of the electrophotographic photoreceptor to the surface of the intermediate transfer member and secondarily transfers the toner image transferred to the surface of the intermediate transfer member to the surface of the recording medium; an apparatus including a cleaning unit that cleans the surface of the electrophotographic photoreceptor after the transfer of the toner image and before the charging; an apparatus including a charge erasing unit that erases the charges on the surface of the electrophotographic photoreceptor by applying the charge erasing light to the surface after the transfer of the toner image and before the charging; and an apparatus including an electrophotographic photoreceptor heating member for increasing the temperature of the electrophotographic photoreceptor and decreasing the relative temperature are employed.

In a case of the intermediate transfer type apparatus, the transfer unit is, for example, configured to include an intermediate transfer member having a surface onto which the toner image is transferred, a primary transfer unit primarily transferring the toner image formed on the surface of the electrophotographic photoreceptor to the surface of the intermediate transfer member, and a secondary transfer unit secondarily transferring the toner image transferred to the surface of the intermediate transfer member to the surface of the recording medium.

The image forming apparatus according to the present exemplary embodiment may be any of a dry development type image forming apparatus or a wet development type (development type using a liquid developer) image forming apparatus.

Further, in the image forming apparatus according to the present exemplary embodiment, for example, the portion including the electrophotographic photoreceptor may have a cartridge structure (process cartridge) that is attachable to and detachable from the image forming apparatus. As the process cartridge, for example, a process cartridge including the electrophotographic photoreceptor according to the present exemplary embodiment is preferably used. Further, the process cartridge may include, for example, at least one selected from the group consisting of a charging unit, an electrostatic latent image forming unit, a developing unit, and a transfer unit in addition to the electrophotographic photoreceptor.

Hereinafter, an example of the image forming apparatus according to the present exemplary embodiment will be described, but the present exemplary embodiment is not limited thereto. Further, main parts shown in the figures will be described, but description of other parts will not be provided.

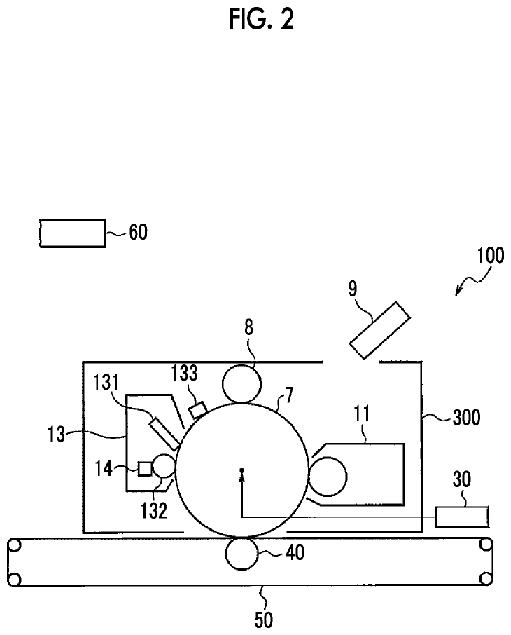

FIG. 2 is a schematic configuration view showing an example of the image forming apparatus according to the present exemplary embodiment.

As shown in FIG. 2, an image forming apparatus 100 according to the present exemplary embodiment includes a process cartridge 300 including an electrophotographic photoreceptor 7, an exposure device 9 (an example of an electrostatic latent image forming unit), a transfer device 40 (primary transfer device), and an intermediate transfer member 50. Further, in the image forming apparatus 100, the exposure device 9 is disposed at a position that can be exposed to the electrophotographic photoreceptor 7 from an opening portion of the process cartridge 300, the transfer device 40 is disposed at a position that faces the electrophotographic photoreceptor 7 via the intermediate transfer member 50, and the intermediate transfer member 50 is disposed such that a part of the intermediate transfer member 50 is in contact with the electrophotographic photoreceptor 7. Although not shown, the image forming apparatus also includes a secondary transfer device that transfers the toner image transferred to the intermediate transfer member 50 to a recording medium (for example, paper). Further, the intermediate transfer member 50, the transfer device 40 (primary transfer device), and the secondary transfer device (not shown) correspond to an example of the transfer unit. In the image forming apparatus 100, a control device 60 (an example of the control unit) is a device that controls the operation of each device and each member in the image forming apparatus 100 and is disposed in connection with each device and each member.

The process cartridge 300 in FIG. 2 integrally supports the electrophotographic photoreceptor 7, a charging device 8 (an example of the charging unit), a developing device 11 (an example of the developing unit), and a cleaning device 13 (an example of the cleaning unit) in a housing. The cleaning device 13 has a cleaning blade (an example of the cleaning member) 131, and the cleaning blade 131 is disposed to come into contact with the surface of the electrophotographic photoreceptor 7. Further, the cleaning member may be a conductive or insulating fibrous member instead of the aspect of the cleaning blade 131, and may be used alone or in combination with the cleaning blade 131.

Further, FIG. 2 shows an example of an image forming apparatus including a fibrous member 132 (roll shape) that supplies a lubricant 14 to the surface of the electrophotographic photoreceptor 7 and a fibrous member 133 (flat brush shape) that assists cleaning, but these are disposed as necessary.

Hereinafter, each configuration of the image forming apparatus according to the present exemplary embodiment will be described.

### Charging Device

As the charging device 8, for example, a contact-type charger formed of a conductive or semi-conductive charging roller, a charging brush, a charging film, a charging rubber blade, a charging tube, or the like is used. Further, a known charger such as a non-contact type roller charger, or a scorotron charger or a corotron charger using corona discharge is also used.

### Exposure Device

Examples of the exposure device 9 include an optical system device that exposes the surface of the electrophotographic photoreceptor 7 to light such as a semiconductor laser beam, LED light, and liquid crystal shutter light in a predetermined image pattern. The wavelength of the light source is within the spectral sensitivity region of the electrophotographic photoreceptor. As the wavelength of a semiconductor laser, near infrared, which has an oscillation wavelength in the vicinity of 780 nm, is mostly used. However, the wavelength is not limited thereto, and a laser having an oscillation wavelength of approximately 600 nm or a laser having an oscillation wavelength of 400 nm or greater and 450 nm or less as a blue laser may also be used. Further, a surface emission type laser light source capable of outputting a multi-beam is also effective for forming a color image.

### Developing Device

Examples of the developing device 11 include a typical developing device that performs development in contact or non-contact with the developer. The developing device 11 is not particularly limited as long as the developing device has the above-described functions, and is selected depending on the purpose thereof. Examples of the developing device include known developing machines having a function of attaching a one-component developer or a two-component developer to the electrophotographic photoreceptor 7 using a brush, a roller, or the like. Among these, for example, a developing device formed of a developing roller having a surface on which a developer is held is preferably used.

The developer used in the developing device 11 may be a one-component developer containing only a toner or a two-component developer containing a toner and a carrier. Further, the developer may be magnetic or non-magnetic. Known developers are employed as these developers.

### Cleaning Device

As the cleaning device 13, a cleaning blade type device including the cleaning blade 131 is used.

In addition to the cleaning blade type device, a fur brush cleaning type device or a simultaneous development cleaning type device may be employed.

### Transfer Device

Examples of the transfer device 40 include a known transfer charger such as a contact type transfer charger using a belt, a roller, a film, or a rubber blade, a scorotron transfer charger, or a corotron transfer charger using corona discharge.

### Intermediate Transfer Member

As the intermediate transfer member 50, a belt-like intermediate transfer member (intermediate transfer belt) containing semi-conductive polyimide, polyamide-imide, polycarbonate, polyarylate, polyester, rubber, or the like is used. Further, as the form of the intermediate transfer member, a drum-like intermediate transfer member may be used in addition to the belt-like intermediate transfer member.

### Control Device

The control device 60 is configured as a computer that controls the entire device and performs various calculations. Specifically, the control device 60 includes, for example, a central processing unit (CPU), a read only memory (ROM) storing various programs, a random access memory (RAM) used as a work area in a case of executing a program, a non-volatile memory storing various pieces of information, and an input/output interface (I/O). The CPU, the ROM, the RAM, the non-volatile memory, and the I/O are connected to each other via a bus. Further, each unit of the image forming apparatus 100, such as the electrophotographic photoreceptor 7 (including a drive motor 30), the charging device 8, the exposure device 9, the developing device 11, and the transfer device 40, is connected to the I/O.

Further, the CPU executes, for example, programs (for example, control programs of an image forming sequence, a recovery sequence, and the like) stored in the ROM or the non-volatile memory, and controls the operation of each unit of the image forming apparatus 100. The RAM is used as a work memory. For example, the programs executed by the CPU, data necessary for processing of the CPU, and the like are stored in the ROM and the non-volatile memory. Further, the control programs and various pieces of data may be stored in another storage device such as a storage unit, or may be acquired from an outside via a communication unit.

Further, various drives may be connected to the control device 60. Examples of the various drives include a device that reads data from a computer-readable portable recording medium, such as a flexible disk, an optical magnetic disk, a CD-ROM, a DVD-ROM, or a universal serial bus (USB) memory, or writes data on a recording medium. In a case where various drives are provided, the control program may be recorded in a portable recording medium and executed by the corresponding drive reading the program.

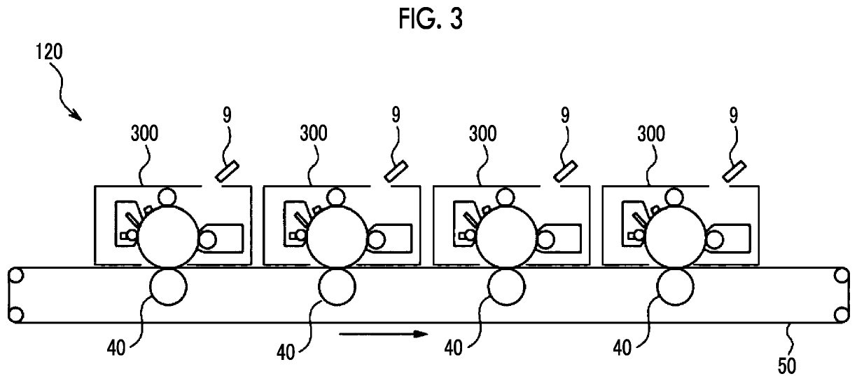

FIG. 3 is a schematic configuration view showing another example of the image forming apparatus according to the present exemplary embodiment.

An image forming apparatus 120 shown in FIG. 3 is a tandem type multicolor image forming apparatus on which four process cartridges 300 are mounted. The image forming apparatus 120 is formed such that four process cartridges 300 are arranged in parallel on the intermediate transfer member 50, and one electrophotographic photoreceptor is used for each color. Further, the image forming apparatus 120 has the same configuration as the image forming apparatus 100 except that the image forming apparatus 120 is of a tandem type.

Further, the image forming apparatus 100 according to the present exemplary embodiment is not limited to the above-described configuration, and may further include, for example, a first charge erasing device that is provided in the periphery of the electrophotographic photoreceptor 7 and on the downstream side of the transfer device 40 in the rotation direction of the electrophotographic photoreceptor 7 and on the upstream side of the cleaning device 13 in the rotation direction of the electrophotographic photoreceptor and aligns the polarity of the remaining toner and facilitating removal with a cleaning brush; or a second charge erasing device that is provided on the downstream side of the cleaning device 13 in the rotation direction of the electrophotographic photoreceptor and on the upstream side of the charging device 8 in the rotation direction of the electrophotographic photoreceptor and erases the charges on the surface of the electrophotographic photoreceptor 7.

Further, the image forming apparatus 100 according to the present exemplary embodiment is not limited to the above-described configuration, and a known configuration, for example, a direct transfer type image forming apparatus that directly transfers a toner image formed on the electrophotographic photoreceptor 7 to a recording medium may be employed.

### EXAMPLES

Hereinafter, the present disclosure will be described in more detail based on examples, but the present disclosure is not limited to the following examples. The materials, the used amounts, the ratios, the treatment procedures, and the like described in the following examples may be appropriately changed without departing from the spirit of the present disclosure.

### Example 1

### Formation of Undercoat Layer

100 parts by mass of zinc oxide (manufactured by Tayca Corporation, average particle diameter of 70 nm, specific surface area of 15 m²/g) is stirred and mixed with 500 parts by mass of tetrahydrofuran, 1.3 parts by mass of a silane coupling agent (KBM503, manufactured by Shin-Etsu Chemical Co., Ltd.) is added thereto, and the mixture is stirred for 2 hours. Thereafter, tetrahydrofuran is distilled off by vacuum distillation and baked at 120° C. for 3 hours to obtain zinc oxide surface-treated with a silane coupling agent.

110 parts by mass of the surface-treated zinc oxide is stirred and mixed with 500 parts by mass of tetrahydrofuran, a solution in which 0.6 parts by mass of alizarin is dissolved in 50 parts by mass of tetrahydrofuran is added thereto, and the mixture is stirred at 50° C. for 5 hours. Thereafter, zinc oxide to which alizarin is added is filtered off by vacuum filtration, and further dried under reduced pressure at 60° C. to obtain zinc oxide to which alizarin is added.

A mixed solution is obtained by mixing 60 parts by mass of the zinc oxide to which alizarin is added, 13.5 parts by mass of a curing agent (blocked isocyanate, SUMIDUR 3175, manufactured by Sumitomo Bayer Urethane Co., Ltd.), 15 parts by mass of a butyral resin (S-LEC BM-1, manufactured by Sekisui Chemical Co., Ltd.), and 85 parts by mass of methyl ethyl ketone. 38 parts by mass of this mixed solution and 25 parts by mass of methyl ethyl ketone are mixed and dispersed for 2 hours in a sand mill using glass beads having a diameter of 1 mmφ, thereby obtaining a dispersion liquid.

0.005 parts by mass of dioctyltin dilaurate and 40 parts by mass of silicone resin particles (TOSPEARL 145, manufactured by Momentive Performance Materials) are added to the obtained dispersion liquid as a catalyst, thereby obtaining a coating solution for forming an undercoat layer. An aluminum base material having a diameter of 60 mm, a length of 357 mm, and a thickness of 1 mm is coated with the coating solution by a dip coating method, and dried and cured at 170° C. for 40 minutes, thereby forming an undercoat layer having a thickness of 19 μm.

### Formation of Charge Generation Layer

A mixture of 15 parts by mass of hydroxygallium phthalocyanine having diffraction peaks at positions where Bragg angles (2θ±0.2°) in an X-ray diffraction spectrum using Cuka characteristic X-rays are at least 7.3°, 16.0°, 24.9°, and 28.0° as the charge generation material, 10 parts by mass of vinyl chloride-vinyl acetate copolymer resin (VMCH, manufactured by Nippon Unicar Company Limited) as a binder resin, and 200 parts by mass of n-butyl acetate is dispersed in a sand mill for 4 hours using glass beads having a diameter of 1 mmφ. 175 parts by mass of n-butyl acetate and 180 parts by mass of methyl ethyl ketone are added to the obtained dispersion liquid, and the mixture is stirred, thereby obtaining a coating solution for a charge generation layer. The undercoat layer is immersed in and coated with the coating solution for a charge generation layer and dried at room temperature (25° C.), thereby forming a charge generation layer having a film thickness of 0.2 μm.

### Formation of Charge Transport Layer

10 parts by mass of (N,N′-diphenyl-N,N′-bis (3-methylphenyl)-(1,1′-diphenyl)-4,4′-diamine, 10 parts by mass of a bisphenol Z type polycarbonate resin (viscosity average molecular weight: 50,000) as a binder resin, and a cyclic siloxane compound (1) in the content listed in Table 2 are added, stirred, and mixed for 12 hours while 95 parts by mass of tetrahydrofuran is maintained at a liquid temperature of 20° C., thereby obtaining a coating solution for forming a charge transport layer.

The charge generation layer is coated with the coating solution for forming a charge transport layer and dried at 135° C. for 40 minutes to form a charge transport layer having a film thickness of 30 μm. A photoreceptor (1) in which the undercoat layer, the charge generation layer, and the charge transport layer are laminated and formed in this order on the aluminum base material is obtained by performing the above-described steps.

### Examples 2 to 17 and Comparative Examples 1 to 7

Each photoreceptor is obtained in the same manner as in Example 1 except that the kind and the addition amount of the cyclic siloxane compound are changed as listed in Table 1 in the formation of the charge transport layer. Further, in Comparative Example 1, the cyclic siloxane compound is not added.

The details of the cyclic siloxane compound used in each example are described below.
Compound (1): specific example No. 1 of cyclic siloxane compound described above (X=succinic anhydride, number of X's=2, R=methyl group, n=1)
Compound (2): specific example No. 8 of cyclic siloxane compound described above (X=succinic anhydride, number of X's=4, R=methyl group, n=1)
Compound (3): specific example No. 9 of cyclic siloxane compound described above (X=acrylic group, number of X's=4, R=methyl group, n=1)
Compound (4): specific example No. 2 of cyclic siloxane compound described above (X=acrylic group, number of X's=2, R=methyl group, n=1)
Compound (5): specific example No. 11 of cyclic siloxane compound described above (X=alicyclic epoxy group, number of X's=4, R=methyl group, n=1)
Compound (6): specific example No. 4 of cyclic siloxane compound described above (X=alicyclic epoxy group, number of X's=2, R=methyl group, n=1)
Compound (7): specific example No. 13 of cyclic siloxane compound described above (X=amino group, number of X's=4, R=methyl group, n=1)
KP340: Silicone oil “KP340”, manufactured by Shin-Etsu Chemical Co., Ltd.

### Evaluation

The surface roughness Ra of the outermost layer (that is, the charge transport layer) of the photosensitive layer is measured by the above-described method and evaluated according to the following standards.

A: The Ra is 5 nm or less

B: The Ra is greater than 5 nm and 10 nm or less

C: The Ra is greater than 10 nm and 15 nm or less

D: The Ra is greater than 15 nm

TABLE 2

| | | Addition | | |
|---|---|---|---|---|
| | Cyclic | amount | Surface roughness Ra | |
| | siloxane | [ppm] | [nm] | Evaluation |
| Example 1 | Compound (1) | 0.01 | 5.0 | A |
| Example 2 | Compound (2) | 0.01 | 5.0 | A |
| Example 3 | Compound (3) | 0.01 | 4.9 | A |
| Example 4 | Compound (4) | 0.01 | 5.0 | A |
| Example 5 | Compound (7) | 0.01 | 4.8 | A |
| Example 6 | Compound (1) | 1 | 4.5 | A |
| Example 7 | Compound (2) | 1 | 4.8 | A |
| Example 8 | Compound (3) | 1 | 4.7 | A |
| Example 9 | Compound (4) | 1 | 4.6 | A |
| Example 10 | Compound (7) | 1 | 4.8 | A |
| Example 11 | Compound (1) | 10 | 4.2 | A |
| Example 12 | Compound (2) | 10 | 4.1 | A |
| Example 13 | Compound (3) | 10 | 4.0 | A |
| Example 14 | Compound (4) | 10 | 4.3 | A |
| Example 15 | Compound (7) | 10 | 4.4 | A |
| Example 16 | Compound (5) | 0.01 | 8.8 | B |
| Example 17 | Compound (6) | 0.01 | 9.0 | B |
| Comparative | None | 0 | 16 | D |
| Example 1 | | | | |
| Comparative | KP340 | 0.01 | 11 | C |
| Example 2 | | | | |
| Comparative | Compound (1) | 0.0005 | 12 | C |
| Example 3 | | | | |
| Comparative | Compound (2) | 0.0005 | 12 | C |
| Example 4 | | | | |
| Comparative | Compound (3) | 0.0005 | 12 | C |
| Example 5 | | | | |
| Comparative | Compound (4) | 0.0005 | 12 | C |
| Example 6 | | | | |
| Comparative | Compound (7) | 0.0005 | 12 | C |
| Example 7 | | | | |

As listed in the tables, it may be seen that the surface roughness Ra of the electrophotographic photoreceptor of the examples is reduced as compared with the electrophotographic photoreceptor of the comparative examples.

The present exemplary embodiment includes the following aspects.

(((1)))

An electrophotographic photoreceptor comprising:
a base material; and
a photosensitive layer on the base material,
wherein an outermost layer constituting an outermost surface contains a total of 0.0010 ppm or greater of at least one selected from the group consisting of cyclic siloxane compounds represented by General Formulae (1), (2), (3), and (4),

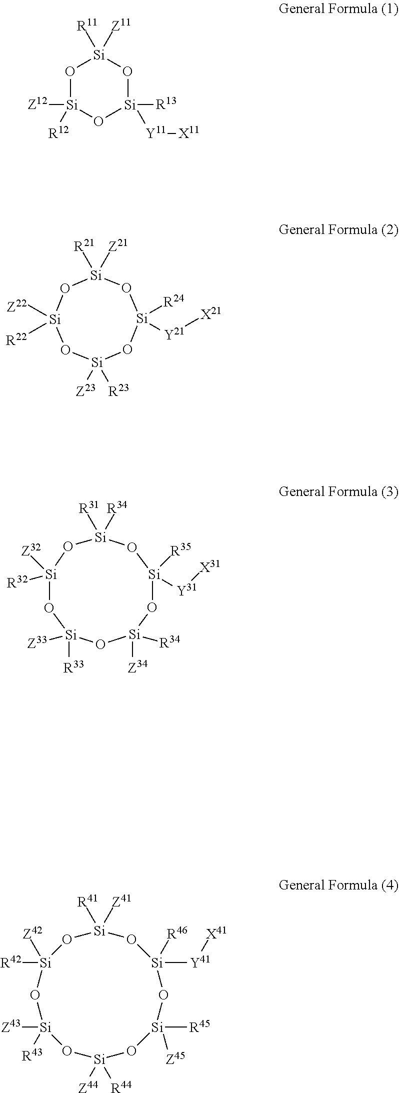

(in General Formulae (1), (2), (3), and (4), R¹¹, R¹², R¹³, R²¹, R²², R²³, R²⁴, R³¹, R³², R³³, R³⁴, R³⁵, R⁴¹, R⁴², R⁴³, R⁴⁴, R⁴⁵, and R⁴⁶ each independently represent a hydrogen atom or a monovalent alkyl group that may have a substituent, Z¹¹, Z¹², Z²¹, Z²², Z²³, Z³¹, Z³², Z³³, Z³⁴, Z⁴¹, Z⁴², Z⁴³, Z⁴⁴, and Z⁴⁵ each independently represent a group represented by —Y¹²—X¹², a hydrogen atom, or a monovalent alkyl group that may have a substituent, X¹¹, X¹², X²¹, X²², X³¹, X³², X⁴¹, and X⁴² each independently represent a monovalent functional group selected from the group consisting of a succinic anhydride group, a (meth)acrylic group, an alicyclic epoxy group, an amino group, a hydroxyl group, and a glycidyl group, and Y¹¹, Y¹², Y²¹, Y²², Y³¹, Y³², Y⁴¹, and Y⁴² each independently represent a divalent organic linking group).

(((2)))

The electrophotographic photoreceptor according to (((1))),
wherein the outermost layer contains a total of 0.0010 ppm or greater of the cyclic siloxane compound represented by General Formula (2).

(((3)))

The electrophotographic photoreceptor according to (((2))),
wherein one or three of Z²¹, Z²², and Z²³ in the cyclic siloxane compound represented by General Formula (2) represent a group represented by —Y¹²—X¹².

(((4)))

The electrophotographic photoreceptor according to (((3))),
wherein, in the cyclic siloxane compound represented by General Formula (2), Z²² represents a group represented by —Y¹²—X¹², and Z²¹ and Z²³ represent a hydrogen atom or a monovalent alkyl group.

(((5)))

The electrophotographic photoreceptor according to any one of (((1))) to (((4))),
wherein X¹¹, X¹², X²¹, X²², X³¹, X³², X⁴¹, and X⁴² in General Formulae (1), (2), (3), and (4) each independently represent a monovalent functional group selected from the group consisting of a succinic anhydride group, a (meth)acrylic group, and an amino group.

(((6)))

The electrophotographic photoreceptor according to any one of (((1))) to (((5))), wherein Y¹¹, Y¹², Y²¹, Y²², Y³¹, Y³², Y⁴¹, and Y⁴² in General Formulae (1), (2), (3), and (4) each independently represent a divalent organic linking group represented by —(CH₂)ₙ—, where n represents 1 or greater and 8 or less.

(((7)))

The electrophotographic photoreceptor according to any one of (((1))) to (((6))),
wherein R¹¹, R¹², R¹³, R²¹, R²², R²³, R²⁴, R³¹, R³², R³³, R³⁴, R³⁵, R⁴¹, R⁴², R⁴³, R⁴⁴, R⁴⁵, and R⁴⁶ in General Formulae (1), (2), (3), and (4) each independently represent a hydrogen atom or a monovalent alkyl group having 1 or more and 10 or less carbon atoms that may have a substituent.

(((8)))

The electrophotographic photoreceptor according to any one of (((1))) to (((7))),
wherein the electrophotographic photoreceptor contains a total of 0.005 ppm or greater and 20 ppm or less of the cyclic siloxane compound.

(((9)))

The electrophotographic photoreceptor according to (((8))),
wherein the electrophotographic photoreceptor contains a total of 0.1 ppm or greater and 15 ppm or less of the cyclic siloxane compound.

(((10)))

The electrophotographic photoreceptor according to any one of (((1))) to (((9))),
wherein an outer peripheral surface of the outermost layer has a surface roughness Ra of 15 nm or less.

(((11)))

The electrophotographic photoreceptor according to (((10))),
wherein the outer peripheral surface of the outermost layer has a surface roughness Ra of 1 nm or greater and 10 nm or less.

(((12)))

A process cartridge comprising:
the electrophotographic photoreceptor according to any one of (((1))) to (((11))),
wherein the process cartridge is attachable to and detachable from an image forming apparatus.

(((13)))

An image forming apparatus comprising:
the electrophotographic photoreceptor according to any one of (((1))) to (((11));
a charging unit that charges a surface of the electrophotographic photoreceptor;
an electrostatic latent image forming unit that forms an electrostatic latent image on the charged surface of the electrophotographic photoreceptor;
a developing unit that develops the electrostatic latent image formed on the surface of the electrophotographic photoreceptor with a developer containing a toner to form a toner image; and
a transfer unit that transfers the toner image to a surface of a recording medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrophotographic photoreceptor comprising:
a base material; and
a photosensitive layer on the base material,
wherein an outermost layer constituting an outermost surface contains a total of 0.0010 ppm or greater of at least one selected from the group consisting of cyclic siloxane compounds represented by General Formulae (1), (2), (3), and (4), 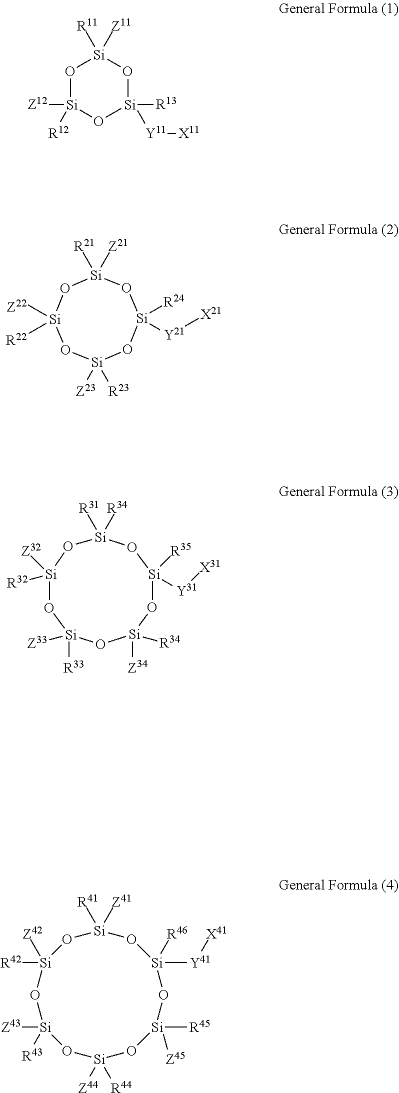
(in General Formulae (1), (2), (3), and (4), R¹¹, R¹², R¹³, R²¹, R²², R²³, R²⁴, R³¹, R³², R³³, R³⁴, R³⁵, R⁴¹, R⁴², R⁴³, R⁴⁴, R⁴⁵, and R⁴⁶ each independently represent a hydrogen atom or a monovalent alkyl group that may have a substituent, Z¹¹, Z¹², Z²¹, Z²², Z²³, Z³¹, Z³², Z³³, Z³⁴, Z⁴¹, Z⁴², Z⁴³, Z⁴⁴, and Z⁴⁵ each independently represent a group represented by —Y¹²—X¹², a hydrogen atom, or a monovalent alkyl group that may have a substituent, X¹¹, X¹², X²¹, X²², X³¹, X³², X⁴¹, and X⁴² each independently represent a monovalent functional group selected from the group consisting of a succinic anhydride group, a (meth)acrylic group, an alicyclic epoxy group, an amino group, a hydroxyl group, and a glycidyl group, and Y¹¹, Y¹², Y²¹, Y²², Y³¹, Y³², Y⁴¹, and Y⁴² each independently represent a divalent organic linking group).

2. The electrophotographic photoreceptor according to claim 1,
wherein the outermost layer contains a total of 0.0010 ppm or greater of the cyclic siloxane compound represented by General Formula (2).

3. The electrophotographic photoreceptor according to claim 2,
wherein one or three of Z²¹, Z²², and Z²³ in the cyclic siloxane compound represented by General Formula (2) represent a group represented by —Y¹²—X¹².

4. The electrophotographic photoreceptor according to claim 3,
wherein, in the cyclic siloxane compound represented by General Formula (2), Z²² represents a group represented by —Y¹²—X¹², and Z²¹ and Z²³ represent a hydrogen atom or a monovalent alkyl group.

5. The electrophotographic photoreceptor according to claim 1,
wherein X¹¹, X¹², X²¹, X²², X³¹, X³², X⁴¹, and X⁴² in General Formulae (1), (2), (3), and (4) each independently represent a monovalent functional group selected from the group consisting of a succinic anhydride group, a (meth)acrylic group, and an amino group.

6. The electrophotographic photoreceptor according to claim 1,
wherein Y¹¹, Y¹², Y²¹, Y²², Y³¹, Y³², Y⁴¹, and Y⁴² in General Formulae (1), (2), (3), and (4) each independently represent a divalent organic linking group represented by —(CH₂)ₙ—, where n represents 1 or greater and 8 or less.

7. The electrophotographic photoreceptor according to claim 1,
wherein R¹¹, R¹², R¹³, R²¹, R²², R²³, R²⁴, R³¹, R³², R³³, R³⁴, R³⁵, R⁴¹, R⁴², R⁴³, R⁴⁴, R⁴⁵, and R⁴⁶ in General Formulae (1), (2), (3), and (4) each independently represent a hydrogen atom or a monovalent alkyl group having 1 or more and 10 or less carbon atoms that may have a substituent.

8. The electrophotographic photoreceptor according to claim 1,
wherein the electrophotographic photoreceptor contains a total of 0.005 ppm or greater and 20 ppm or less of the cyclic siloxane compound.

9. The electrophotographic photoreceptor according to claim 8,
wherein the electrophotographic photoreceptor contains a total of 0.1 ppm or greater and 15 ppm or less of the cyclic siloxane compound.

10. The electrophotographic photoreceptor according to claim 1,
wherein an outer peripheral surface of the outermost layer has a surface roughness Ra of 15 nm or less.

11. The electrophotographic photoreceptor according to claim 10,
wherein the outer peripheral surface of the outermost layer has a surface roughness Ra of 1 nm or greater and 10 nm or less.

12. A process cartridge comprising:
the electrophotographic photoreceptor according to claim 1,
wherein the process cartridge is attachable to and detachable from an image forming apparatus.

13. An image forming apparatus comprising:
the electrophotographic photoreceptor according to claim 1;
a charging unit that charges a surface of the electrophotographic photoreceptor;
an electrostatic latent image forming unit that forms an electrostatic latent image on the charged surface of the electrophotographic photoreceptor;
a developing unit that develops the electrostatic latent image formed on the surface of the electrophotographic photoreceptor with a developer containing a toner to form a toner image; and
a transfer unit that transfers the toner image to a surface of a recording medium.
